(19) United States
(12) Patent Application Publication
(10) Pub. No.: US 2017/0055324 A1
(43) Pub. Date: Feb. 23, 2017

(54) APPARATUS, RETROFIT KIT, AND METHOD OF ENERGY EFFICIENT ILLUMINATION USING ADJUSTMENT SCHEDULES

(71) Applicant: Express Imaging Systems, LLC, Renton, WA (US)

(72) Inventor: William G. Reed, Seattle, WA (US)

(21) Appl. No.: 15/238,129

(22) Filed: Aug. 16, 2016

Related U.S. Application Data
(60) Provisional application No. 62/208,403, filed on Aug. 21, 2015.

(51) Int. Cl. H05B 33/08; H02J 3/38; H02J 7/35; H05B 37/02

(52) U.S. Cl. CPC H05B 33/0845; H05B 37/0227; H05B 37/0218; H05B 37/0272; H05B 37/0281; H05B 33/0896; H02J 3/383; H02J 7/35

(57) ABSTRACT

An illumination system reduces a level of light output, and hence power consumption, at a time after turning ON a light source, and increases the level of light output at a time prior to turning OFF the light source. A control subsystem can determine when to increase the level of light based on a predicted time when the light source will be turned OFF. The control subsystem may determine an average or median length of time that the light source has been turned on for a number of recent daily cycles. A control subsystem may be an integral part of a luminaire or may be a retrofit.

### BACKGROUND

Technical Field

The present disclosure generally relates to the field of illumination devices and, more particularly, to control of illumination to improve energy efficiency.

Description of the Related Art

Energy conservation has become of ever increasing importance. Efficient use of energy can result in a variety of benefits, including financial benefits such as cost savings and environmental benefits such as preservation of natural resources and reduction in “green house” (e.g., CO₂) gas emissions.

Residential, commercial, and street lighting which illuminate interior and exterior spaces consume a significant amount of energy. Conventional lighting devices or luminaires exist in a broad range of designs, suitable for various uses. Lighting devices employ a variety of conventional light sources, for example incandescent lamps, fluorescent lamps such as high-intensity discharge (HID) lamps (e.g., mercury vapor lamps, high-pressure sodium lamps, metal halide lamps).

There appear to be two primary approaches to reducing energy consumption associated with lighting systems. One approach employs higher efficiency light sources. The other approach selectively provides light only when needed.

Use of higher efficiency light sources may, for instance, include replacing incandescent lamps with fluorescent lamps or even with solid-state light sources (e.g., light emitting diodes (LEDs), organic LEDs (OLEDs), polymer LEDs (PLEDs)) to increase energy efficiency. In some instances, these higher efficiency light sources may present a number of problems. For example, fluorescent light sources take a relatively long time after being turned ON to achieve their full rated level of output light or illumination. Such light sources also typically have a high energy consumption during warm-up. Additionally, many higher efficiency light sources emit light with a low color rendering index (CRI). For reference, sunlight has a CRI of 100 and represents “ideal light” which contains a continuous spectrum of visible radiation. Low CRI light is less pleasing to the human eye. Surfaces illuminated with low CRI light may not be perceived in their “true” color. Low CRI light makes it more difficult to discern details, often requiring a higher level of light or illumination output to discern details that would otherwise be discernable in high CRI light at a lower level of illumination. Further, higher efficiency light sources may require additional circuitry (e.g., ballasts) and/or thermal management techniques (e.g., passive or active cooling).

Providing illumination only when needed can be achieved manually by a user of the lighting system, or automatically by a control mechanism. Automatic control mechanisms generally fall into two broad categories, timers and environmental sensors. Timer based control mechanisms turn light sources ON and OFF based on time. The times are typically user configurable. Such relies on the user to account for changes or variations in the length of daylight in a 24 hour cycle which may occur throughout a year. Very often, timer based control mechanisms are set once and never updated.

Environmental sensor based control mechanisms sense light or illumination levels and/or motion or proximity. Light or illumination level based control mechanisms are commonly referred to dusk-to-dawn sensors. Dusk-to-dawn light or illumination level based control mechanisms turn the light sources ON when a level of light or illumination in an environment falls below a turn ON threshold (i.e., dusk threshold), and turn the light sources OFF when the level of light or illumination exceeds a turn OFF threshold (i.e., dawn threshold). Light or illumination level based control subsystems advantageously automatically accommodate changes in length of day light throughout the year.

Motion or proximity based control mechanisms (e.g., passive infrared sensor based motion sensors) turn light sources ON when motion or proximity is detected. Motion or proximity based control mechanisms turn light sources OFF after some defined period of time if no further motion or proximity is detected during that period of time. Sensitivity of the motion or proximity based control mechanisms is typically user configurable, as is the duration between turn ON and turn OFF. However, motion or proximity based control mechanisms have limited range (e.g., 10 meters), limiting the number of applications in which such may be effectively employed. Motion or proximity based control mechanisms may also be ineffective where the ambient air temperature or temperature of an object is close to that of the trigger temperature (e.g., temperature of human body). Some lighting control mechanisms employ both light or illumination level based and motion or proximity based techniques. Such lighting control mechanisms turn light sources ON only if motion is detected while the level of light or illumination in the environment is below the turn ON threshold. Thus, the motion or proximity sensing is active only between dusk and dawn.

Sometimes these approaches are incompatible with each other. For example, the relatively long time for fluorescent light sources to produce full output hinders the effective use of such light sources with motion or proximity based control mechanisms. Further, many control mechanisms are built into the luminaire. Such makes it difficult or even impossible to modify operation of the control mechanism beyond some simple user settings (e.g., sensitivity, duration between turn ON and turn OFF).

Additionally, some entities are deploying renewable energy generation sources (e.g., photovoltaic arrays, wind powered micro-turbines) to generate renewable power. For instance, entities such as utilities, governmental units such as municipalities, private entities such as a retailer, shopping malls, or other venues with parking lots or other area lighting requirements, are deploying renewable energy generation sources, which may, for example feed into a grid, line or mains power network, e.g., electrical power utility network. The renewable energy generation sources and associated energy storage devices are often deployed as retrofits to existing luminaire installations, which can limit operational flexibility. For example, the control circuitry of the legacy luminaire may have no ability to determine whether power is being supplied via the grid, line or mains power supply or via a dischargeable and/or rechargeable power storage device (e.g., secondary battery cells, ultra-capacitor cells).

New approaches to improving the energy efficiency of lighting systems are desirable.

### BRIEF SUMMARY

As previously explained, lighting systems which use dusk-to-dawn control mechanisms typically provides light at a continuous, relatively high, level from dusk to dawn. The exception to such appears to be when motion or proximity based sensing is included in such a control mechanism. In many instances, a high level of lighting or illumination is not necessary throughout the entire period. For instance, in retail business or corporate office parking lots high levels of light or illumination are typically only useful into the late evening hours (e.g., 10 PM or 11 PM) and early morning hours (e.g., 4 AM or 5 AM). High level lighting or illumination between the late evening and early morning hours provides little benefit. A lower level of light or illumination during such hours may achieve sufficient illumination for some desired purpose (e.g., security), while reducing energy consumption.

Use of a low level lighting or illumination during such hours may also make practical use of relatively slow warm up light sources with motion or proximity based control mechanisms since the illumination sources may only need to be warmed up from an already turned ON, but reduced output, state instead of warming up from an OFF state.

Thus, it may useful to operate a luminaire according to an illumination adjustment or “dimming” schedule which, for example dims the output to some non-zero level of illumination at some time after turn ON (e.g., at dusk), and increases the level of illumination at some time before turn OFF (e.g., at dawn). An illumination adjustment or dimming schedule may specify more than one downward adjustment between turn ON and turn OFF and/or may specify more than one upward adjustment between turn ON and turn OFF. An illumination adjustment or dimming schedule may specify a respective level of illumination for each downward and/or upward adjustment, for example a non-zero level of illumination (e.g., in lumens, duty cycle, voltage, current). An illumination adjustment or dimming schedule may specify one or more conditions or triggers for respective adjustments. For example, an illumination adjustment or dimming schedule may specify one or more triggers or conditions in terms of times (e.g., real-world time), time periods following an event (e.g., minutes, hours, percentage or other portion of daily cycle, percentage or other portion of “night-time” (i.e., dusk-to-dawn) portion of daily cycle), and/or in terms of events, for instance solar or daily cycle events (e.g., detection of an ambient light condition that corresponds to dusk, detection of an ambient light condition that corresponds to dawn, solar midnight, solar noon).

In some implementations, a signal from a dusk-to-dawn sensor (e.g., ambient light sensor) may be employed for turning ON and turning OFF the luminaire, with operation between turn ON and turn OFF controlled according to an illumination adjustment or dimming schedule. In other implementations, an illumination adjustment or dimming schedule may additionally specify turn ON information and/or turn OFF information. For example, an illumination adjustment or dimming schedule may specify a level of illumination for initially being turned ON in a daily cycle, and/or a trigger or condition that triggers turn ON, e.g., detection of an ambient light condition correspondence that corresponds to dusk. Also for example, an illumination adjustment or dimming schedule may specify a trigger or condition that triggers turn ON, e.g., detection of an ambient light condition that corresponds to dawn. In such implementations, the ambient light sensor may be advantageously repurposed, for example to detect faults or aberrant conditions and/or to measure or at least estimate an amount of solar insolation received during some period (e.g., most immediate dawn-to-dusk cycle, most immediate daily cycle, two or more most immediate dawn-to-dusk cycles or daily cycles).

It may be useful to store two or more illumination adjustment or dimming schedules to select from, for example based on an ability to provide power from a dischargeable power source, which advantageously may be rechargeable, e.g., an array of secondary battery cells or ultra-capacitor cells. Thus, an appropriate illumination adjustment or dimming schedule can be selected from two or more illumination adjustment or dimming schedules based on an ability to provide electrical power to a luminaire from the dischargeable and/or rechargeable power source. The selection may be based on an actual or at least an estimated amount of power required, for example an amount of power required to power the luminaire during the most immediate dusk-to-dawn cycle. The selection may be based on an actual or estimate amount of power stored by the dischargeable and/or rechargeable power source. For example, the determination or estimation may be based on an amount of solar insolation received in a most immediate dawn-to-dusk cycle, for example as measured or sensed by a repurposed ambient light sensor. In use, a “more aggressive” adjustment or dimming schedule may be selected and executed when the amount of stored power is relatively high, particularly with respect to an estimated amount of power that will be required to power the luminaire through at least one cycle (e.g., most immediate dusk-to-dawn cycle). In use, a “less aggressive” adjustment or dimming schedule may be selected and executed when the amount of stored power is relatively low, particularly with respect to an estimated amount of power that will be required to power the luminaire through at least one cycle (e.g., most immediate dusk-to-dawn cycle).

The estimated power that will be required to power the luminaire through at least one cycle may be based at least in part on an actual or estimated duration of that cycle (e.g., most immediate dusk-to-dawn cycle). The actual or estimated duration of a cycle may be determined in a variety of ways. For example, the actual or estimated duration of a dusk-to-dawn cycle may be based on a duration of one or more most immediately preceding dusk-to-dawn cycles. Such may average or determine a median of a plurality of most immediately preceding dusk-to-dawn cycles to account for transitory conditions, for instance passing headlights. Additionally or alternatively, the actual or estimated duration of a dusk-to-dawn cycle may, for example, be based on a location of the luminaire. Location information may be stored in a memory and/or derived from a satellite positioning system (e.g., GPS), or other system (e.g., cellular network, WI-FI network, etc. A knowledge of latitude, and optionally longitude, along with a knowledge of a date or approximate date (e.g., real-world clock and/or calendar), can be used to determine an estimate of the most immediate dusk-to-dawn cycle.

In some implementations, new illumination adjustment or dimming schedules may be stored, either in addition to or as replacement to existing illumination adjustment or dimming schedules.

A luminaire control system to control operation of a luminaire may be summarized as including: at least one communications port to provide communications with a device that is remote from the luminaire; and at least one controller coupled to control operation of a luminaire, the at least one controller communicatively coupled to the communications port to at least receive signals via the communications port, the controller responsive to at least a first signal to enter into a stored energy consuming mode in response to receipt of the first signal, and in the stored energy consuming mode the at least one controller determines whether there is sufficient stored power to power the luminaire through a dusk-to-dawn cycle, independent of whether electrical power to power the luminaire is available via a line, grid or mains power source.

In the stored energy consuming mode, the at least one controller may determine whether to apply an illumination adjustment schedule based at least in part on an at least estimate of a length of the dusk-to-dawn cycle and based at least in part on an at least estimate of stored power available to power the luminaire through the dusk-to-dawn cycle. In the stored energy consuming mode, the at least one controller may select between two or more dimming schedules based at least in part on an at least estimate of stored power available to power the luminaire through the dusk-to-dawn cycle. In the stored energy consuming mode, the at least one controller may cause execution of a first illumination adjustment schedule that controls an illumination level of the luminaire during a dusk to dawn period. At least the first illumination adjustment schedule executed by the at least one controller may specify a period of time in which the luminaire is controlled to output at a reduced but non-zero level of illumination with respect to another period. At least the first illumination adjustment schedule executed by the at least one controller may specify a first ON period of time in which the luminaire is controlled to output at a relatively high level, a second ON period of time in which the luminaire is controlled to output at a relatively reduced but non-zero level of illumination with respect to the first ON period of time while motion is not sensed, and a third ON period of time in which the luminaire is controlled to output at a relatively high level with respect to the second ON period of time. At least the first illumination adjustment schedule executed by the at least one controller may specify a first ON period of time in which the luminaire is controlled to output at a relatively high level but not maximum level while motion is not sensed, a second ON period of time in which the luminaire is controlled to output at a relatively reduced but non-zero level of illumination with respect to the first ON period of time while motion is not sensed, and a third ON period of time in which the luminaire is controlled to output at a relatively high level but not maximum level while motion is not sensed with respect to the second ON period of time. In the stored energy consuming mode, the at least one controller may compare the at least estimated power available to power the luminaire through the dusk-to-dawn cycle to a respective estimated amount of power required to power the luminaire through the dusk-to-dawn cycle for each of a plurality of dimming schedules. In the stored energy consuming mode, the at least one controller may select the illumination adjustment schedule based at least in part on the comparison of the at least estimated power available to power the luminaire through the dusk-to-dawn cycle and the respective estimated amount of power required to power the luminaire through the dusk-to-dawn cycle for each of the plurality of dimming schedules. In the stored energy consuming mode, the at least one controller may select the illumination adjustment schedule further based at least in part on at least one specified condition of illumination to be placed on operation of the luminaire during the dusk-to-dawn cycle. In the stored energy consuming mode, the at least one controller may select the illumination adjustment schedule further based at least in part on at least one specified duration of a maximum illumination by the luminaire for a set period of time with respect to a solar event during the dusk-to-dawn cycle inclusive of a dusk event and a dawn event. In the stored energy consuming mode, the at least one controller may estimate power available to power the luminaire through the dusk-to-dawn cycle based at least in part on an at least an estimate of solar insolation that occurred in at least a portion of a most immediate dawn-to-dusk cycle. In the stored energy consuming mode, the at least one controller may operate the luminaire via power from a power storage device, independent of whether electrical power is available via a mains power source. The luminaire may be a legacy installation and may be electrically coupled to a rechargeable power storage device which is electrically coupled to a renewable energy source, wherein the rechargeable power storage device and the renewable energy source are retrofits to the legacy installation, and in the stored energy consuming mode, the at least one controller determines whether there is sufficient stored power stored in the rechargeable power storage device to power the luminaire through the dusk-to-dawn cycle. In the stored energy consuming mode, the at least one controller may at least estimate an amount of power generated by the renewable energy source in the most immediate dawn-to-dusk cycle in order to determine whether there is sufficient stored power stored in the rechargeable power storage device to power the luminaire through the dusk-to-dawn cycle. In the stored energy consuming mode, the at least one controller may integrate a signal indicative of an output value of a light sensitive transducer over at least a portion of the most immediate dawn-to-dusk cycle in order to at least estimate an amount of power generated by the renewable energy source in the most immediate dawn-to-dusk cycle. The luminaire may be a legacy installation and may be electrically coupled to at least one of a battery cell array or a super-capacitor array which is electrically coupled to a renewable energy source, wherein the rechargeable power storage device and the renewable energy source are retrofits to the legacy installation, and in the stored energy consuming mode, the at least one controller determines whether there is sufficient stored power stored in the at least one of the battery cell array or the super-capacitor array to power the luminaire through the dusk-to-dawn cycle. At least one communications port may be a wired communications port that provides a physical interface that provides wired communications. At least one communications port may be a wireless communications port that provides wireless communications via transmission and receipt of electromagnetic energy. At least one communications port may receive at least one configuration signal which specifies a new dimming schedule, and in response stores the new illumination adjustment schedule to a nontransitory processor-readable medium. The luminaire control system may further include: at least one global positioning receiver communicatively coupled to the at least one controller to provide information thereto indicative of at least one of a latitude or a longitude of the luminaire, wherein the at least one controller determines the at least an estimate of the length of the dusk-to-dawn cycle based on the information indicative of the at least one of the latitude or the longitude of the luminaire. The luminaire control system may further include: at least one nontransitory processor-readable medium that stores location information indicative of at least one of a latitude or a longitude of the luminaire, wherein the at least one controller determines the at least an estimate of the length of the dusk-to-dawn cycle based on the information indicative of the at least one of the latitude or the longitude of the luminaire.

A method of operation in a luminaire control system may be summarized as including: receiving at least a first signal via a communications port, in response to receipt of the first signal, entering into a stored energy consuming mode by at least one controller, and in the stored energy consuming mode, determining, by the at least one controller, whether there is sufficient stored power to power a luminaire through a dusk-to-dawn cycle, independent of whether electrical power to power the luminaire is available via a line, grid or mains power source.

The method may further include: in the stored energy consuming mode, determining, by the at least one controller, whether to apply an illumination adjustment schedule based at least in part on an at least estimate of a length of the dusk-to-dawn cycle and based at least in part on an at least estimate of stored power available to power the luminaire through the dusk-to-dawn cycle. The method may further include: in the stored energy consuming mode, selecting, by the at least one controller, between two or more dimming schedules based at least in part on an at least estimate of stored power available to power the luminaire through the dusk-to-dawn cycle. The method may further include: in the stored energy consuming mode, causing, by the at least one controller, an execution of a first illumination adjustment schedule that controls an illumination level of the luminaire during a dusk to dawn period. Causing an execution of a first illumination adjustment schedule may include executing the first illumination adjustment schedule that specifies a period of time in which the luminaire is controlled to output at a reduced but non-zero level of illumination with respect to another period. Causing an execution of a first illumination adjustment schedule may include executing the first illumination adjustment schedule that specifies a first ON period of time in which the luminaire is controlled to output at a relatively high level, a second ON period of time in which the luminaire is controlled to output at a relatively reduced but non-zero level of illumination with respect to the first ON period of time while motion is not sensed, and a third ON period of time in which the luminaire is controlled to output at a relatively high level with respect to the second ON period of time. Causing an execution of a first illumination adjustment schedule may include executing the first illumination adjustment schedule that specifies a first ON period of time in which the luminaire is controlled to output at a relatively high level but not maximum level while motion is not sensed, a second ON period of time in which the luminaire is controlled to output at a relatively reduced but non-zero level of illumination with respect to the first ON period of time while motion is not sensed, and a third ON period of time in which the luminaire is controlled to output at a relatively high level but not maximum level while motion is not sensed with respect to the second ON period of time. The method may further include: in the stored energy consuming mode, comparing, by the at least one controller, the at least estimated power available to power the luminaire through the dusk-to-dawn cycle to a respective estimated amount of power required to power the luminaire through the dusk-to-dawn cycle for each of a plurality of dimming schedules. The method may further include: in the stored energy consuming mode, selecting, by the at least one controller, the illumination adjustment schedule based at least in part on the comparison of the at least estimated power available to power the luminaire through the dusk-to-dawn cycle and the respective estimated amount of power required to power the luminaire through the dusk-to-dawn cycle for each of the plurality of dimming schedules. The method may further include: in the stored energy consuming mode, selecting, by the at least one controller, the illumination adjustment schedule further based at least in part on at least one specified condition of illumination to be placed on operation of the luminaire during the dusk-to-dawn cycle. The method may further include: in the stored energy consuming mode, selecting, by the at least one controller, the illumination adjustment schedule further based at least in part on at least one specified duration of a maximum illumination by the luminaire for a set period of time with respect to a solar event during the dusk-to-dawn cycle inclusive of a dusk event and a dawn event. The method may further include: in the stored energy consuming mode, estimating, by the at least one controller, an amount of power available to power the luminaire through the dusk-to-dawn cycle based at least in part on an at least an estimate of solar insolation that occurred in at least a portion of a most immediate dawn-to-dusk cycle. The method may further include: in the stored energy consuming mode, operating, by the at least one controller, the luminaire via power from a power storage device, independent of whether electrical power is available via a mains power source. The luminaire may be a legacy installation and may be electrically coupled to a rechargeable power storage device which is electrically coupled to a renewable energy source, wherein the rechargeable power storage device and the renewable energy source are retrofits to the legacy installation, and in the stored energy consuming mode, determining, by the at least one controller, whether there is sufficient stored power stored in the rechargeable power storage device to power the luminaire through the dusk-to-dawn cycle. The method may further include: in the stored energy consuming mode, at least estimating, by the at least one controller, an amount of power generated by the renewable energy source in the most immediate dawn-to-dusk cycle in order to determine whether there is sufficient stored power stored in the rechargeable power storage device to power the luminaire through the dusk-to-dawn cycle. The method may further include: in the stored energy consuming mode, integrating, by the at least one controller, a signal indicative of an output value of a light sensitive transducer over at least a portion of the most immediate dawn-to-dusk cycle in order to at least estimate an amount of power generated by the renewable energy source in the most immediate dawn-to-dusk cycle. The method may further include: receiving the signals via a wired communications port that provides a physical interface that provides wired communications. The method may further include: receiving the signals as via a wireless communications port as wireless communications via transmission and receipt of electromagnetic energy. The method may further include: receiving, by at least one communications port, at least one configuration signal which specifies a new dimming schedule, and storing the new illumination adjustment schedule to a nontransitory processor-readable medium. The method may further include: generating, by at least one global positioning receiver, information thereto indicative of at least one of a latitude or a longitude of the luminaire, and wherein the determining the at least an estimate of the length of the dusk-to-dawn cycle is based on the information indicative of the at least one of the latitude or the longitude of the luminaire. The method may further include: retrieving from at least one nontransitory processor-readable medium, location information indicative of at least one of a latitude or a longitude of the luminaire, and wherein the determining the at least an estimate of the length of the dusk-to-dawn cycle is based on the information indicative of the at least one of the latitude or the longitude of the luminaire.

A luminaire control system to control operation of a luminaire may be summarized as including: at least one nontransitory processor-readable medium that stores at least one of processor executable instructions or data; and at least one controller communicatively coupled to the at least one nontransitory processor-readable medium and coupled to control operation of the luminaire, the at least one controller which in at least one mode determines whether there is sufficient stored power to power the luminaire through a dusk-to-dawn cycle, independent of whether electrical power to power the luminaire is available via a line, grid or mains power source.

In the at least one mode, the at least one controller may determine whether to apply an illumination adjustment schedule based at least in part on an at least estimate of a length of the dusk-to-dawn cycle and based at least in part on an at least estimate of stored power available to power the luminaire through the dusk-to-dawn cycle. In the at least one mode, the at least one controller may select between two or more dimming schedules based at least in part on an at least estimate of stored power available to power the luminaire through the dusk-to-dawn cycle, and may execute the selected one of the dimming schedules to control an illumination level of the luminaire during a dusk to dawn period. At least the selected illumination adjustment schedule executed by the at least one controller may specify a period of time in which the luminaire is controlled to output at a reduced but non-zero level of illumination with respect to another period. In the at least one mode, the at least one controller may compare the at least estimated power available to power the luminaire through the dusk-to-dawn cycle to a respective estimated amount of power required to power the luminaire through the dusk-to-dawn cycle for each of a plurality of dimming schedules. In the at least one mode, the at least one controller may estimate power available to power the luminaire through the dusk-to-dawn cycle based at least in part on an at least an estimate of solar insolation that occurred in at least a portion of a most immediate dawn-to-dusk cycle. In the at least one mode, the at least one controller may integrate a signal indicative of an output value of a light sensitive transducer over at least a portion of the most immediate dawn-to-dusk cycle in order to at least estimate an amount of power generated by the renewable energy source in the most immediate dawn-to-dusk cycle. The luminaire control system may further include: at least one global positioning receiver communicatively coupled to the at least one controller to provide information thereto indicative of at least one of a latitude or a longitude of the luminaire, wherein the at least one controller determines the at least an estimate of the length of the dusk-to-dawn cycle based on the information indicative of the at least one of the latitude or the longitude of the luminaire. The at least one nontransitory processor-readable medium may store location information indicative of at least one of a latitude or a longitude of the luminaire, and the least one controller may determine the at least an estimate of the length of the dusk-to-dawn cycle based on the information indicative of the at least one of the latitude or the longitude of the luminaire.

A method of operation in a luminaire control system to control operation of a luminaire may be summarized as including: in at least one mode, determining, by at least one controller, whether there is sufficient stored power to power the luminaire through a dusk-to-dawn cycle, independent of whether electrical power to power the luminaire is available via a line, grid or mains power source; and controlling the luminaire via stored power independent of whether electrical power to power the luminaire is available via a line, grid or mains power source. The method may further include: in the at least one mode, determining, by the at least one controller, whether to apply an illumination adjustment schedule based at least in part on an at least estimate of a length of the dusk-to-dawn cycle and based at least in part on an at least estimate of stored power available to power the luminaire through the dusk-to-dawn cycle. The method may further include: in the at least one mode, selecting, by the at least one controller, between two or more dimming schedules based at least in part on an at least estimate of stored power available to power the luminaire through the dusk-to-dawn cycle, and executes the selected one of the dimming schedules to control an illumination level of the luminaire during a dusk to dawn period. In response to at least the selected dimming schedule, the controlling the luminaire via stored power may include controlling the luminaire to output at a reduced but non-zero level of illumination with respect to another period. The method may further include: in the at least one mode, comparing, by the at least one controller, the at least estimated power available to power the luminaire through the dusk-to-dawn cycle to a respective estimated amount of power required to power the luminaire through the dusk-to-dawn cycle for each of a plurality of dimming schedules. The method may further include: in the at least one mode, estimating, by the at least one controller, an amount of power available to power the luminaire through the dusk-to-dawn cycle based at least in part on an at least an estimate of solar insolation that occurred in at least a portion of a most immediate dawn-to-dusk cycle. The method may further include: in the at least one mode, integrating, by the at least one controller, a signal indicative of an output value of a light sensitive transducer over at least a portion of the most immediate dawn-to-dusk cycle in order to at least estimate an amount of power generated by the renewable energy source in the most immediate dawn-to-dusk cycle. The method may further include: generating, by at least one global positioning receiver, information thereto indicative of at least one of a latitude or a longitude of the luminaire, and wherein the determining the at least an estimate of the length of the dusk-to-dawn cycle is based on the information indicative of the at least one of the latitude or the longitude of the luminaire. The method may further include: retrieving from at least one nontransitory processor-readable medium, location information indicative of at least one of a latitude or a longitude of the luminaire, and wherein the determining the at least an estimate of the length of the dusk-to-dawn cycle is based on the information indicative of the at least one of the latitude or the longitude of the luminaire.

A luminaire control system to control operation of a luminaire may be summarized as including: at least one nontransitory processor-readable medium that stores at least one of processor executable instructions or data; and at least one controller communicatively coupled to the at least one nontransitory processor-readable medium and coupled to control operation of a luminaire, the at least one controller which in at least one mode the at least one controller determines whether to apply an illumination adjustment schedule based at least in part on an at least estimate of a length of the dusk-to-dawn cycle and based at least in part on an at least estimate of stored power available to power the luminaire through the dusk-to-dawn cycle.

In the at least one mode, the at least one controller may select between two or more dimming schedules based at least in part on an at least estimate of stored power available to power the luminaire through the dusk-to-dawn cycle, and may execute the selected one of the dimming schedules to control an illumination level of the luminaire during a dusk to dawn period. At least the selected illumination adjustment schedule executed by the at least one controller may specify a period of time in which the luminaire is controlled to output at a reduced but non-zero level of illumination with respect to another period. In the at least one mode, the at least one controller may compare the at least estimated power available to power the luminaire through the dusk-to-dawn cycle to a respective estimated amount of power required to power the luminaire through the dusk-to-dawn cycle for each of a plurality of dimming schedules. In the at least one mode, the at least one controller may estimate power available to power the luminaire through the dusk-to-dawn cycle based at least in part on an at least an estimate of solar insolation that occurred in at least a portion of a most immediate dawn-to-dusk cycle. In the at least one mode, the at least one controller may integrate a signal indicative of an output value of a light sensitive transducer over at least a portion of the most immediate dawn-to-dusk cycle in order to at least estimate an amount of power generated by the renewable energy source in the most immediate dawn-to-dusk cycle. The luminaire control system may further include: at least one global positioning receiver communicatively coupled to the at least one controller to provide information thereto indicative of at least one of a latitude or a longitude of the luminaire, wherein the at least one controller determines the at least an estimate of the length of the dusk-to-dawn cycle based on the information indicative of the at least one of the latitude or the longitude of the luminaire. The at least one nontransitory processor-readable medium may store location information indicative of at least one of a latitude or a longitude of the luminaire, and the at least one controller determines the at least an estimate of the length of the dusk-to-dawn cycle based on the information indicative of the at least one of the latitude or the longitude of the luminaire.

A method of operation in a luminaire control system to control operation of a luminaire may be summarized as including: in at least one mode, determining, by at least one controller, whether to apply a illumination adjustment schedule based at least in part on an at least estimate of a length of the dusk-to-dawn cycle and based at least in part on an at least estimate of stored power available to power the luminaire through the dusk-to-dawn cycle; and controlling the luminaire via stored power independent of whether electrical power to power the luminaire is available via a line, grid or mains power source.

The method may further include: in the at least one mode, selecting, by the at least one controller, between two or more dimming schedules based at least in part on an at least estimate of stored power available to power the luminaire through the dusk-to-dawn cycle, and may execute the selected one of the dimming schedules to control an illumination level of the luminaire during a dusk to dawn period. Controlling the luminaire via stored power may include controlling the luminaire according to the selected illumination adjustment schedule which specifies a period of time in which the luminaire is controlled to output at a reduced but non-zero level of illumination with respect to another period. The method may further include: in the at least one mode, comparing, by the at least one controller, the at least estimated power available to power the luminaire through the dusk-to-dawn cycle to a respective estimated amount of power required to power the luminaire through the dusk-to-dawn cycle for each of a plurality of dimming schedules. The method may further include: in the at least one mode, estimating, by the at least one controller, an amount of power available to power the luminaire through the dusk-to-dawn cycle based at least in part on an at least an estimate of solar insolation that occurred in at least a portion of a most immediate dawn-to-dusk cycle. The method may further include: in the at least one mode, integrating, by the at least one controller, a signal indicative of an output value of a light sensitive transducer over at least a portion of the most immediate dawn-to-dusk cycle in order to at least estimate an amount of power generated by the renewable energy source in the most immediate dawn-to-dusk cycle. The method may further include: generating, by at least one global positioning receiver, information thereto indicative of at least one of a latitude or a longitude of the luminaire, and wherein the determining the at least an estimate of the length of the dusk-to-dawn cycle may be based on the information indicative of the at least one of the latitude or the longitude of the luminaire. The method may further include: retrieving from at least one nontransitory processor-readable medium, location information indicative of at least one of a latitude or a longitude of the luminaire, and wherein the determining the at least an estimate of the length of the dusk-to-dawn cycle may be based on the information indicative of the at least one of the latitude or the longitude of the luminaire.

A luminaire control system to control operation of a luminaire may be summarized as including: at least one nontransitory processor-readable medium that stores at least one of processor executable instructions or data; and at least one controller communicatively coupled to the at least one nontransitory processor-readable medium and coupled to control operation of a luminaire, the at least one controller which in at least one mode the at least one controller selects between two or more dimming schedules based at least in part on an at least estimate of stored power available to power the luminaire through the dusk-to-dawn cycle and, and executes the selected one of the dimming schedules to control an illumination level of the luminaire during a dusk to dawn period.

At least the selected illumination adjustment schedule executed by the at least one controller may specify a period of time in which the luminaire is controlled to output at a reduced but non-zero level of illumination with respect to another period. In the at least one mode, the at least one controller may compare the at least estimated power available to power the luminaire through the dusk-to-dawn cycle to a respective estimated amount of power required to power the luminaire through the dusk-to-dawn cycle for each of a plurality of dimming schedules. In the at least one mode, the at least one controller may estimate power available to power the luminaire through the dusk-to-dawn cycle based at least in part on an at least an estimate of solar insolation that occurred in at least a portion of a most immediate dawn-to-dusk cycle. In the at least one mode, the at least one controller may integrate a signal indicative of an output value of a light sensitive transducer over at least a portion of the most immediate dawn-to-dusk cycle in order to at least estimate an amount of power generated by the renewable energy source in the most immediate dawn-to-dusk cycle. The luminaire control system may further include: at least one global positioning receiver communicatively coupled to the at least one controller to provide information thereto indicative of at least one of a latitude or a longitude of the luminaire, wherein the at least one controller determines the at least an estimate of the length of the dusk-to-dawn cycle based on the information indicative of the at least one of the latitude or the longitude of the luminaire. The at least one nontransitory processor-readable medium may store location information indicative of at least one of a latitude or a longitude of the luminaire, and the at least one controller may determine the at least an estimate of the length of the dusk-to-dawn cycle based on the information indicative of the at least one of the latitude or the longitude of the luminaire.

A method of operation in a luminaire control system to control operation of a luminaire may be summarized as including: in at least one mode, selecting, by at least one controller, between two or more dimming schedules based at least in part on an at least estimate of stored power available to power the luminaire through the dusk-to-dawn cycle and, and executes the selected one of the dimming schedules to control an illumination level of the luminaire during a dusk to dawn period; and controlling the luminaire via stored power independent of whether electrical power to power the luminaire is available via a line, grid or mains power source.

Controlling the luminaire via stored power may include controlling the luminaire according to the selected illumination adjustment schedule which specifies a period of time in which the luminaire is controlled to output at a reduced but non-zero level of illumination with respect to another period. The method may further include: in the at least one mode, comparing, by the at least one controller, the at least estimated power available to power the luminaire through the dusk-to-dawn cycle to a respective estimated amount of power required to power the luminaire through the dusk-to-dawn cycle for each of a plurality of dimming schedules. The method may further include: in the at least one mode, estimating, by the at least one controller, an amount of power available to power the luminaire through the dusk-to-dawn cycle based at least in part on an at least an estimate of solar insolation that occurred in at least a portion of a most immediate dawn-to-dusk cycle. The method may further include: in the at least one mode, integrating, by the at least one controller, a signal indicative of an output value of a light sensitive transducer over at least a portion of the most immediate dawn-to-dusk cycle in order to at least estimate an amount of power generated by the renewable energy source in the most immediate dawn-to-dusk cycle. The method may further include: generating, by at least one global positioning receiver, information thereto indicative of at least one of a latitude or a longitude of the luminaire, and wherein the determining the at least an estimate of the length of the dusk-to-dawn cycle is based on the information indicative of the at least one of the latitude or the longitude of the luminaire. The method may further include: retrieving from at least one nontransitory processor-readable medium, location information indicative of at least one of a latitude or a longitude of the luminaire, and wherein the determining the at least an estimate of the length of the dusk-to-dawn cycle is based on the information indicative of the at least one of the latitude or the longitude of the luminaire.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is an isometric view of a luminaire and light source installed on a pole, with a photovoltaic array, power storage device and control system (e.g., retrofit control system) coupled to control operation of the light source according to one or more schedules, according to at least one non-limiting illustrated embodiment.

FIG. 2 is a schematic diagram of the light source, renewable energy generation source, power storage device and control system of FIG. 1, according to another non-limiting illustrated embodiment.

FIG. 3 is a flow diagram of a method 300 of operation in a luminaire control system to control operation of a luminaire, according to at least one non-limiting illustrated embodiment.

FIG. 4A is a graph showing a level of illumination or output versus time over two daily cycles during a first part of a year, according to another non-limiting illustrated embodiment.

FIG. 4B is a graph showing a level of illumination or output versus time over two daily cycles during a second part of a year.

FIG. 4C is a graph showing a level of illumination or output versus time over two daily cycles during the second part of a year, according to another non-limiting illustrated embodiment wherein a length of time of high intensity illumination varies as a function of total time that the light source ON.

FIG. 4D is a graph showing a level of illumination or output versus time over two daily cycles during the second part of a year, according to another non-limiting illustrated embodiment wherein a length of time of high intensity immediately following turn ON is different from a length of time of high intensity immediately preceding turn OFF of the light source.

FIG. 5 is a graph of a light or illumination level versus time for several daily cycles over the course of a period of time, such as a year.

FIG. 6 is a flow diagram showing a method of operation in a luminaire control system to control operation of a luminaire, according to at least one non-limiting illustrated embodiment, which may be executed as part of executing the method of FIG. 3.

FIG. 7 is a flow diagram showing a method of operation in a luminaire control system to control operation of a luminaire, according to one non-limiting illustrated embodiment, which may be executed as part of executing the method of FIG. 3.

FIG. 8 is a flow diagram showing a method of operation in a luminaire control system to control operation of a luminaire, according to one non-limiting illustrated embodiment, which may be executed as part of executing the method of FIG. 3.

FIG. 9 is a flow diagram showing a method of operation in a luminaire control system to control operation of a luminaire, according to one non-limiting illustrated embodiment, which may be executed as part of executing the method of FIG. 8.

FIG. 10 is a flow diagram showing a method of operation in a luminaire control system to control operation of a luminaire, according to another non-limiting illustrated embodiment, which may be executed as part of executing the method of FIG. 9.

FIG. 11 is a flow diagram showing a method of operation in a luminaire control system to control operation of a luminaire, according to a further non-limiting illustrated embodiment, which may be executed as part of executing the method of FIG. 3.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with luminaires and imaging devices have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. Additionally, the terms lighting and illumination are used herein interchangeably. For instance, the phrases “level of illumination” or “level of light output” have the same meanings. Also, the phrases “illumination source” and “light source” have the same meanings.

The headings and Abstract of the Disclosure provided herein are for convenience only and do not interpret the scope or meaning of the embodiments.

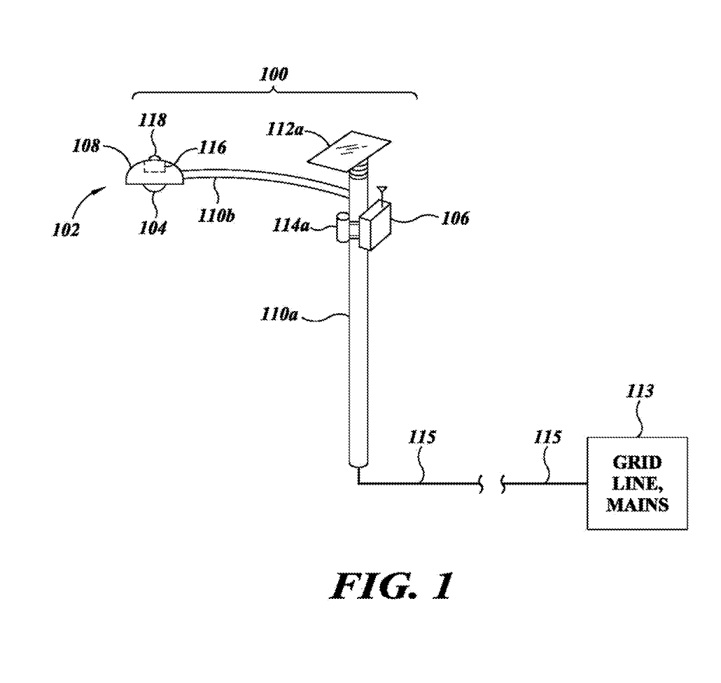

FIG. 1 shows a luminaire system 100 according to one non-limiting illustrated embodiment. The luminaire system 100 includes a luminaire 102 with at least one illumination or light source 104, and a control system 106.

The luminaire 102 may be a legacy luminaire 102, while the control system 106 may be a retrofit control system 106, installed after installation of the legacy luminaire 102. For example, the retrofit control system 106 may be installed in conjunction with installation of a renewable power generation device 112, for example a photovoltaic array 112a or wind powered micro-turbine (not shown), and one or more dischargeable and/or rechargeable power storage devices 114 (e.g., one or more secondary battery cells 114a or ultra-capacitor cells). While generally discussed as a retrofit control system 106 installed after installation of the legacy luminaire 102, many of the structures, methods and approaches described herein can be incorporated in original equipment or an original equipment installation. Thus, claimed subject matter is intended to cover both retrofit and original equipment installations, or any other installations, unless specifically amended to recite a specific type of installation.

The luminaire 102 may take any of a variety of forms. For example, the luminaire 102 may include a housing 108, and optionally a bracket (not shown) to allow the luminaire 102 to be hung from a structure, for instance a pole 110a via an arm 110b. Such may be particularly suited for area lighting, for instance lighting of a street, highway, parking lot, loading or storage area, and the like. The luminaire 102 receives electrical power from an external source of electrical power (e.g., grid, line or mains power source or network) 113 via appropriate wiring 115.

Luminaires may take other forms, for example luminaires for residential security applications, including a single or double shade with respective light sources which are typically attached to a side of a building via a junction box. The optical sensor 118 in such luminaires may be supported from the housing 108 by an arm (not shown), for example via a ball joint (not shown). Such may allow the optical sensor 118 to be positioned and oriented with respect to the housing 108 and any structure to which the housing is mounted.

The luminaire 102 may include a shade (not shown), which may be transparent or translucent, or may be opaque. In some implementations, the luminaire 102 may include a socket, for instance a threaded socket or receptacle, sized to removably or interchangeably receive a base of the light source 104.

The luminaires 102 may be conventional, and commercially available from a large variety of sources, for example the AreaMax™ LED area lighting fixture available from Evluma.

The luminaire 102 may include a built-in or integral dusk-to-dawn control mechanism 116. The dusk-to-dawn control mechanism 116 includes at least one sensor 118 (e.g., photosensor, cadmium sulfide cell, photodiode, phototransistor, ambient light sensor integrated circuit) that is responsive to a level (e.g., energy or intensity) of light or illumination in the environment (e.g., daylight or ambient light). The sensor 118 may be positioned to minimize an effect of the light source 104 on the sensor 118. For example, the sensor 118 may be positioned on top of the housing 108. Typically, the dusk-to-dawn control mechanism 116 is configured to turn the light source 104 ON when a level of light detected by the sensor 118 is below a turn ON threshold and to turn the light source 104 OFF when the level of light detected by the sensor 118 is above a turn OFF threshold. The turn ON and turn OFF thresholds may, or may not, be equal to one another. The turn ON and turn OFF thresholds may be fixed, or may be user configurable or user settable.

The light source 104 may take a variety of forms. The light source may include one or more distinct light bulbs, lights or light emitters. For example, the light source 104 may take the form of one or more incandescent light bulbs. Also for example, the light source 104 may take the form of one or more fluorescent light bulbs such as HID light bulbs or lights, one or more arc lamps, or one or more gas-discharge lamps. Advantageously, the light source 104 may take the form of one or more solid state light sources, for instance an array of light emitting diodes (LEDs), organic LEDs (OLEDs) or polymer LEDs (PLEDs). The light sources do not necessarily have to be enclosed in a blub structure. For example, the light sources may take the form of one-, two-, or even three-dimensional arrays of individual LEDs or strings of LEDs. Where appropriate, the light source 104 may also include a ballast.

The retrofit control system 106 is communicatively and/or electrically coupled between the light source 104 and the one or more dischargeable and/or rechargeable power storage devices 114. The retrofit control system 106 is optionally communicatively and/or electrically coupled with the renewable power generation device 112. The retrofit control system 106 is optionally communicatively and/or electrically coupled with the dusk-to-dawn control mechanism 116 and/or sensor 118.

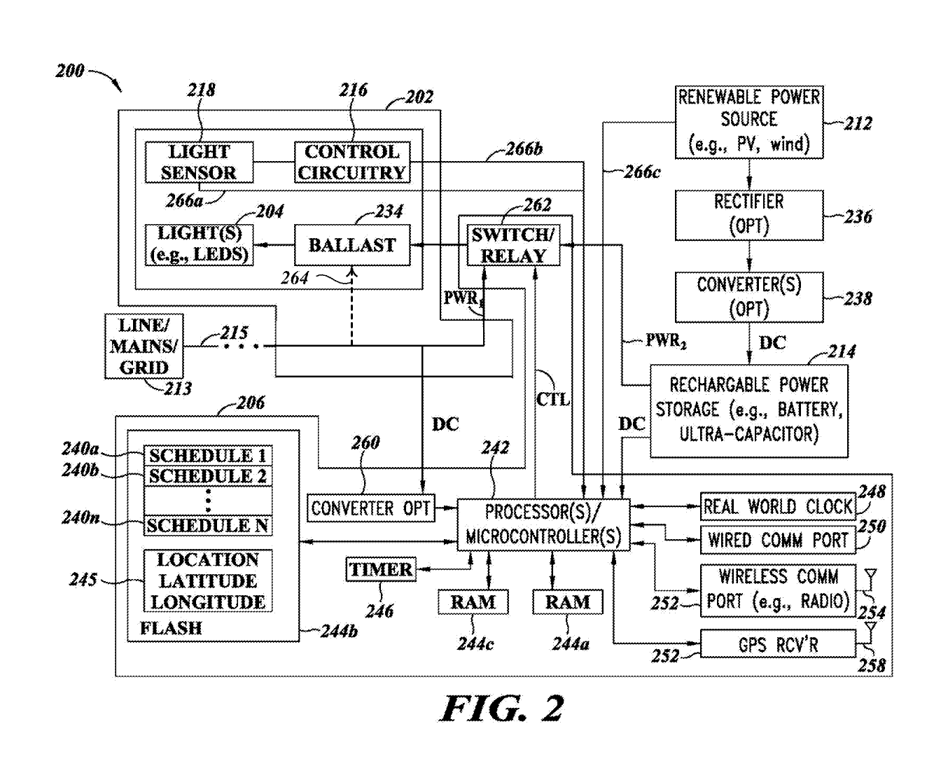

As explained in more detail herein, and in particular with reference to FIG. 2, the retrofit control system 106 includes electrical circuitry or electronics that adjust an illumination level according to an illumination adjustment or dimming schedule or protocol. For example, the retrofit control system 106 may adjust an illumination level produced by the light source 104 downward at a time after the light source is turned ON and adjusts the illumination level upward at a time preceding the light source being turned OFF. Such provides lighting at relatively high levels when illumination is typically most useful, while providing lighting at reduced levels when illumination is not typically useful, thereby reducing energy usage. Such is possible via a retrofit to existing luminaires. Such may avoid the drawbacks associated with motion or proximity based control, such as the limited range of motion or proximity sensors and lack of sensitivity of such sensors in warm climates. As described in more detail below, the retrofit control system 106 may monitor the hours in which the light source 104 is ON or needed, and advantageously employ such in controlling the light source 104. Such can automatically accommodate seasonal changes in the length of daylight or night.

FIG. 2 shows an illumination system 200 according to another non-limiting illustrated embodiment. The illumination system 200 includes a conventional luminaire 202, retrofit control system 206, renewable energy generation source 212 (e.g., photovoltaic array of solar cells, wind powered micro-turbine), and dischargeable and/or rechargeable energy storage device 214 (e.g., secondary battery cell(s), ultra-capacitor cell(s)).

As previously noted, the luminaire(s) 202 may be conventional and commercially available from a large variety of sources. The luminaire 202 includes one or more illumination or light source(s) 204 (e.g., an array of solid-state light sources or emitters, such as LEDs, OLEDs or PLEDs).

Electrical power is typically supplied from an external power source 213 (e.g., grid, line or mains power source or network) via wires or cables 215 (e.g., overhead, underground). The luminaire 202 may include one or more electronic ballasts or drivers 234, for instance where a ballast is needed or useful for the particular type of illumination or light source(s) 204. The ballast(s) or driver(s) 234 condition the supply, line or mains power to provide proper starting and operating electrical conditions (e.g., current, voltage, limiting in-rush current) for the particular illumination or light source(s) 204. The ballast(s) or driver(s) 234 may be an integral or unitary part of the light source(s) 204, or may be a separate discrete component therefrom. The ballast(s) or driver(s) 234 can include a power supply, rectifying AC power and stepping down a voltage of the electrical power supplied from the external power source 213.

A legacy luminaire 202 may optionally include dusk-to-dawn and/or motion sensing control mechanism or circuitry 216 and one or more optical sensors 218. The optical sensor 218 can take any of a variety of forms, including light sensitive or light responsive photosensors, cadmium sulfide cells, photodiodes, phototransistors, ambient light sensor integrated circuits currently commercially available. The control circuitry 216 may be an analog circuit, digital circuit or may include both analog and digital circuit components. Again, a conventional commercially available luminaire with an integral control mechanism may be employed.

In the legacy luminaire 202, the dusk-to-dawn and/or motion sensing control mechanism or circuitry 216 can implement both dusk-to-dawn, and optionally motion or proximity based control. In the legacy luminaire 202, the control mechanism or circuitry 216 relies on signals from the optical sensor 218 to implement motion or proximity sensing only during a period after a level of light or illumination in the environment has fallen below a turn ON threshold (e.g., 10 Lux) and before the level of illuminations exceeds a turn OFF threshold (e.g., 30 Lux). In the legacy luminaire 202, the control mechanism will turn the light source(s) 204 ON for a period of time in response to the detection of motion between dusk and dawn, turning the light source(s) 204 OFF after the period of time. While the turn ON and turn OFF thresholds could be equivalent, such would likely produce undesirable oscillation. Hence, some separation should be maintained between the turn ON and turn OFF thresholds. For example, the turn ON threshold may equal 10 LUX while the turn OFF threshold may equal 30 LUX.

As part of the retrofit, a renewable energy generation source 212 (e.g., photovoltaic array of solar cells, wind powered micro-turbine), dischargeable and/or rechargeable energy storage device 214 (e.g., secondary battery cell(s), ultra-capacitor cell(s)), and one or more power conversion components may be added to the luminaire system 200. Where the renewable energy generation source 212 produces AC power (e.g., wind powered micro-turbine), an optional rectifier 236 may be added to rectify the AC power to DC power, for instance to allow storage of the electrical power by the dischargeable and/or rechargeable energy storage device 214. Additionally or alternatively, one or more power converters 238 (e.g., AC-DC power convert, DC-AC power converter, DC-DC power converter) may added. The power converters 238 may change a waveform of the power and/or step up or step down a voltage thereof, and/or otherwise condition the electrical power.

The retrofit control system 206 is communicatively or electrically coupled to control the light source(s) 204 of the luminaire 202 based at least in part on one or more illumination adjustment or “dimming” schedules 240a-240n (collectively 240).

As discussed above, the retrofit control system 206 includes electrical circuitry or electronics that adjust an illumination level provided by the light source(s) 204 according to an illumination adjustment or “dimming” schedule 240. Such may, for example include adjusting a level of illumination downward at a time after the light source is turned ON and adjusting the illumination level upward at a time preceding the light source being turned OFF. Such provides lighting at relatively high levels when illumination is typically most useful, while providing lighting at reduced levels when illumination is not typically useful, thereby reducing energy usage. Such is possible via a retrofit to existing luminaires 202, and particularly retrofits that are fully operational with retrofitted renewable energy generation source 212 (e.g., photovoltaic array of solar cells, wind powered micro-turbine), and dischargeable and/or rechargeable energy storage device 214 (e.g., secondary battery cell(s), ultra-capacitor cell(s)). Such may avoid the drawbacks associated with motion or proximity based control, such as the limited range of motion or proximity sensors and lack of sensitivity of such sensors in warm climates. As described in more detail below, the retrofit control system 206 can select an appropriate illumination adjustment or dimming schedule 240, monitor the hours in which the light source(s) 204 is ON or needed, and advantageously employ such in controlling the light source(s) 204. Such can automatically accommodate seasonal changes in the length of daylight or night.

The retrofit control system 206 may be identical or similar to the retrofit control subsystem 106 (FIG. 1). The retrofit control system 206 may, for example, include circuitry, for instance one or more controllers 242, e.g., one or more microcontrollers, microprocessors, digital signal processors (DSPs), graphics processing units (GPUs), central processing units (CPUs) with one or more cores, programmable gate arrays (PGAs), application specific integrated circuits (ASICs), programmable logic controllers (PLCs). The retrofit control system 206 may, for example, include circuitry, for instance one or more nontransitory controller-readable storage media 244a-244c (collectively 244) communicatively coupled to the controller 242, which stores controller executable instructions and/or data. The nontransitory controller-readable storage media 244 may take any of a variety of forms, for example nonvolatile memory, volatile memory, read only memory (ROM) 244a, electrically erasable programmable read only memories (EEPROMs), flash memories 224b, random access memory (RAM) 244c, static RAM, dynamic RAM, spinning media for instance magnetic disks or optical disks. The nontransitory controller-readable storage media 244 may, for example, store one or more illumination adjustment or “dimming” schedules 240a-240n. The nontransitory controller-readable storage media 244 may, for example, store one or more pieces of location information 245, for example latitude, longitude, time zone, city, state, country, etc.

The retrofit control system 206 may include one or more timers 246. The timer(s) 246 may be discrete components communicatively coupled to the controller 242, or may be an integral component or function of the controller 242. The timer 246 can be set or operated to determine an amount of time (e.g., seconds, minutes, hours, clock cycles) that has elapsed.

The retrofit control system 206 may optionally, additionally include a real world clock or timer 248 communicatively coupled to the controller 242. The real world clock 248 tracks a date and time in the real world. The real world clock or timer 248 may be correlated or adjusted from time-to-time with an external reference, for instance a time signal emitted by a global positioning system, telecommunications system network (e.g., cellular service provider network), or governmental authority such as National Bureau of Standards' “atomic clock” signals.) The real world clock or timer 248 may take into account a time zone in which the luminaire 202 is located. The location of the luminaire 202 may be defined or identified in a number of ways, as described further herein. The real world clock or timer 248 may provide both time and calendar functions, tracking days or dates in addition to hours and/or minutes.

The retrofit control system 206 may optionally, additionally include one or more wired communications ports 250 to provide wired communications with one or more external devices, for instance external processor-based devices such as desktop or laptop or other types of computers. The wired communications port(s) 250 is/are communicatively coupled to the controller 242. The wired communications port(s) 250 may take any of a large variety of forms, for instance various styles of Ethernet ports, USB ports, RJ-11 ports, HDMI ports, etc.

The retrofit control system 206 may optionally, additionally include one or more wireless communications ports 252 to provide wireless communications with one or more external devices, for instance external processor-based devices such as remote controllers, laptop computers, tablet computers, and/or smartphones. The wireless communications port(s) 252 is/are communicatively coupled to the controller 242. The wireless communications port(s) 252 may take the form of various types of radios (i.e., wireless transmitters, wireless receivers, wireless transceivers) and associated antenna(s) 254. The wireless communications port(s) may additionally or alternatively take the form of one or more optical transmitters, optical receivers, optical transceivers (e.g., infrared transmitters, receivers, transceivers).

The retrofit control system 206 may optionally, additionally include a global positioning receiver or radio 256 and associated antenna(s) 258. The global positioning receiver or radio 256 is communicatively coupled to the controller 242. For instance, the retrofit control system 206 may include one or more global positioning receivers 256 for the U.S. Global Positioning System (GPS), the Russian Globalnaya Navigatsionnaya Sputnikovaya Sistema (GLOSNASS) global positioning system and/or Europe's Galileo global positioning system. Thus, the retrofit control system 206 can determine its own physical location, and hence the location of the associated luminaire(s) 202.

Alternatively, the retrofit control system 206 may receive location information from an external device that includes a global positioning receiver or radio, for instance via the wired or wireless communications ports 250, 252.

As a further alternative, the retrofit control system 206 may receive location information via the wireless communications port, for instance from a telecommunications system network (e.g., cellular service provider network), WI-FI network, Internet, or governmental authority or privately operated system or network.

Location information can be stored in nontransitory controller-readable media, for instance in Flash memory 244b. In some instances, location information can be stored in Flash memory 244b before or during installation of the retrofit control system 206. In other instances, location information can be stored in Flash memory 244b after installation of the retrofit control system 206.

The retrofit control system 206 may optionally include a power converter 260, to rectify, step down a voltage and otherwise transform or condition supplied electrical power to a form suitable to power the controller 242, nonvolatile storage media 244 and/or other components of the retrofit control subsystem 206. Additionally or alternatively, retrofit control system 206 may receive power supplied via the electronic ballasts or drivers 234 and conditioned thereby, which is some implementations may allow the optional converter 260 to be omitted. Additionally or alternatively, the controller 242 and other components of the retrofit control system 206 may receive electrical power from the dischargeable and/or rechargeable energy storage device 214 (e.g., secondary battery cell(s), ultra-capacitor cell(s)).

The retrofit control system 206 is electrically coupled to control at least the light source(s) 204 of the luminaire 202, for example via at least one or more switches 262 (e.g., contact switches, relays, transistors, triacs, IGBTs, power MOSFETs). For example, the controller 242 applies control signals CTL to the switch(es) 262. The control signals may, for example take the form of pulse width modulated signals, currents, voltage levels, or information specifying any of the same, or specifying duty cycle or an ON/OFF condition or state. The switch(es) 262 are illustrated in FIG. 2 as part of the retrofit control system 206. In some implementations the switch(es) 262 may be part of the legacy luminaire 202, and the retrofit control system 206 communicatively coupled to control the switch(es) 262, for instance via a socket and receptacle connection. In such implementations, the switch(es) 262 may be part of the dusk-to-dawn and/or motion sensing control mechanism or circuitry 216. In some implementations, the retrofit control subsystem 206 can use one or more switches 262 to switch in or out individual or groups of light emitters (e.g., arrays or strings of LEDs) that make up one or more light sources 204, or lamp controllers which control the light sources 204.

In the legacy luminaire 202, power may be routed from the external power source 213 (e.g., grid, line or mains power source or network) to the light source(s) 204 via the ballast(s) or driver(s) 234 as illustrated in FIG. 2 by broken line arrow 264. Once the control system 206 is installed, power PWR₁ may be routed from the external power source 213 (e.g., grid, line or mains power source or network) to the light source(s) 204 via the switch(es) 262 and the ballast(s) or driver(s) 234. Power PWR₂ may also be routed from the rechargeable energy storage device 214 (e.g., secondary battery cell(s), ultra-capacitor cell(s)), to the light source(s) 204 via the switch(es) 262 and the ballast 234. Power may be supplied directly from the rechargeable energy storage device 214, particularly where the light source(s) 204 employ DC power. Alternatively, the power may be supplied to the light source(s) 204 via a power converter, rectifier, and/or transformer.

The controller 242 can receive information from the light sensor 218 either directly (arrow 266a) or via the control circuitry (arrow 266b). This information may be indicative of or represent an amount of solar insolation received during a given dawn-to-dusk cycle or daily or diurnal cycle. The controller 242 may employ such information as a proxy for the amount of power available to operate the light source(s) 204 and/or luminaire 206 during a most immediate or upcoming dusk-to-dawn cycle.

Additionally or alternatively, this information may be indicative of or represent a length of a dawn-to-dusk cycle relative to a length of a dusk-to-dawn cycle during a given daily cycle. The controller 242 may employ such information in determining an amount of power or estimated amount of power that will be required to operate the light source(s) 204 and/or luminaire 206 during a most immediate or upcoming dusk-to-dawn cycle, which is typically a function of the length of the particular dusk-to-dawn cycle.

The controller 242 can receive information from the renewable energy generation source 212 (e.g., photovoltaic array of solar cells (arrow 266c). This information may be indicative of or represent an amount of solar insolation received during a given dawn-to-dusk cycle or daily or diurnal cycle. The controller 242 may employ such information as a proxy for the amount of power available to operate the light source(s) 204 and/or luminaire 206 during a most immediate or upcoming dusk-to-dawn cycle.

As previously noted, the retrofit control system 206 can receive signals from the control mechanism or circuitry 216 or light sensor 218, which signals are indicative of when the control mechanism 306 attempts to turn the light source 308 ON and OFF in response to a sensed illumination level being below a turn ON threshold and below a turn OFF threshold, respectively, or alternatively indicative of a level of illumination in the ambient environment. The signals may be as simple as high/low voltage signals. The controller 242 of the retrofit control system 206 may store information to the nonvolatile storage media 244 related to the turning ON and OFF conditions or the turning ON and OFF of the light source(s) 204. For example, the controller 242 can determine a length of time between a successive turning ON and turning OFF signal in the daily cycle, which may be indicative of a length of time between dusk and dawn events. The turning ON and OFF can determine an average or median for the lengths of time for each of a number of daily cycles. The controller 242 can use the average or median length of time to perform a number of functions. For example, the controller 242 can determine the length of the dusk-to-dawn period, and hence the amount of power that may be required to power the light source(s) 204 through any give dusk-to-dawn period. Notably, the dusk-to-dawn period varies throughout the year in most latitudes. Also for example, the controller 242 can determine or predict when or how long after a turn ON event a turn OFF event will occur. Such allows the controller 242 to determine when to increase a level of illumination provided by the light source before the predicted turn OFF event.

The controller 242 can also use the determined the length of the dusk-to-dawn period to select an appropriate illumination adjustment or dimming schedule. For example, the controller can select an appropriate illumination adjustment or dimming schedule based on a determined or estimated length of the dusk-to-dawn cycle and hence power requirement to power the light source(s) 204 and/or other circuitry, and based on a determined or estimate amount of stored power, as well as a level of aggressiveness (e.g., relative level of power consumptiveness) between various available adjustment or dimming schedule.

The controller 242 can also use the determined average or median in setting lengths of time at which a particular level of illumination will be produced. For example, the controller 242 may set the length of time or period following turning ON during which the illumination level is maintained high. The controller 242 may set the length of time or period preceding turning OFF during which the illumination level is maintained high. Additionally or alternatively, the controller 242 may set the length of time or period during which the illumination level is maintained low. In one example, the average or median total length of time between turning ON and turning OFF may be divided into three periods, a first period immediately following turning ON when illumination is at a first level (e.g., relative high) a second period immediately following the first period when illumination is reduced to a second level (e.g., relatively low), and a third period immediately following the second period and preceding turning OFF during which the illumination is increased to a third level (e.g., relatively high). The first and the third periods may be equal (i.e., approximately equal durations) to one another (e.g., 4 hours), with the second period varying in length according to the length of nighttime over the year. Alternatively, the three periods may be equal to one another, the periods varying over the year.

Further, the controller 242 can determine if a current length of time is significantly less (e.g., outside a defined threshold) than an average or median length of time. Such may indicate that the sensors are detecting an artificial source of light, for example light other than solar insolation. In such a situation, the controller 242 may ignore the length of time from the current daily cycle when calculating the average or median. For instance, the controller 242 may not store the current length to the nonvolatile storage media 244, so as to prevent that particular current length from being used in future determinations of averages or median.

In response to a current length of time being significantly less than an average or median length of time, the controller 242 may trigger a new teaching or training cycle. During a teaching or training cycle, the microcontroller may maintain a constant level of light during the entire period between turning ON and turning OFF. Such may allow the controller 242 to collect new information and establish a new average or median. The new teaching or training cycle may last for a single daily cycle or multiple daily cycles.

As previously noted, in some implementations, the retrofit control system 206 may include a real world or solar clock or timer 248 (i.e., a clock that tracks time in the real world or with respect to the sun, rather than an internal clock of a processor based system). Alternatively, the controller 242 may implement a real world or solar clock or timer 248. Such embodiments may also include a discrete internal power source (e.g., battery cells, capacitors, super- or ultracapacitors, fuel cell) to supply power to the real world clock or timer 248 while power is not being received from the control mechanism 302 of the luminaire. The internal power source 322 may be rechargeable, via the power supply circuitry 313. The controller 242 may determine solar midnight, from time-to-time (e.g., each daily cycle). In particular, the controller 242 may divide the average or median time that the light source is ON in half, which should occur at the darkest time of the daily cycle (e.g., solar midnight). The controller 242 may calibrate the real time clock with the determined solar midnight. The controller 242 may control the increasing and decreasing of the level of light output by the light source using the calibrated real time clock. This can prevent or reduce the effect of artificial lights on the illumination system 200.

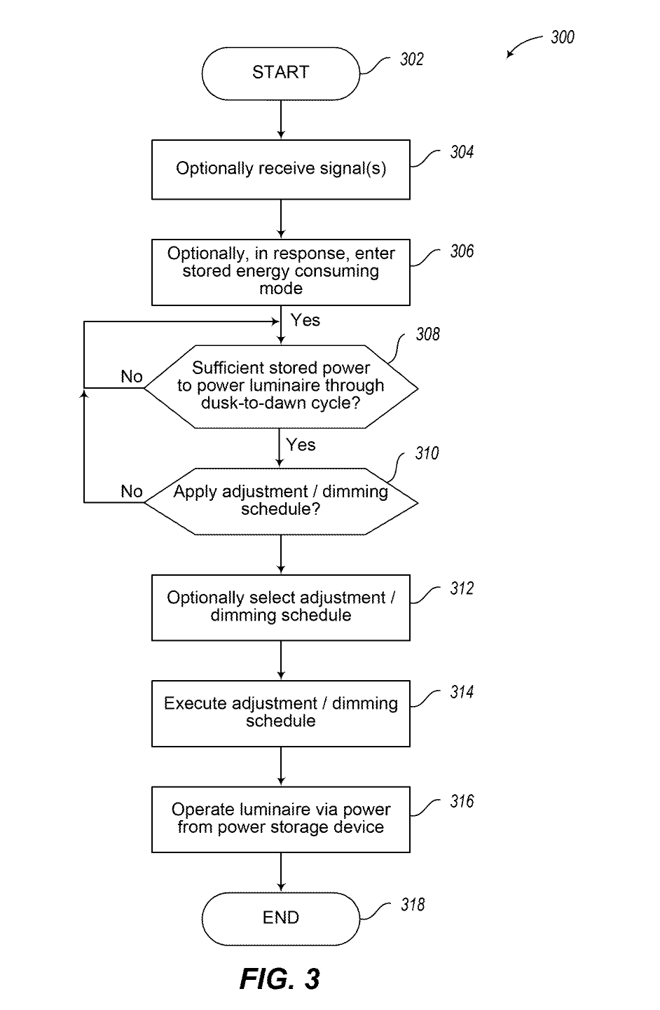

The operation is further described with reference to the methods illustrated in FIGS. 3 and 6-11, below.

FIG. 3 shows a method 300 of operation in a luminaire control system to control operation of a luminaire, according to one illustrated embodiment.

At 302, the method 300 starts, for example in response to an application of power to the luminaire control system, or invocation of a program, subprogram, or routine by a call program, subprogram or routine executed by a processor (e.g., microprocessor, microcontroller, ASIC, PGA, PLU, DSP, GPU).

Optionally at 304, the luminaire control system (e.g., at least one controller of the luminaire control system) receives one or more first signals via a communications port (e.g., wired communications port, wireless communications port). The first signals may represent a command to enter a stored energy consuming mode in which the luminaire control system controls operation of the luminaire to use or consume energy stored in a dischargeable, and rechargeable energy storage device (e.g., one or more battery cells, ultra-capacitor cells). This may advantageously, allow use of energy generated via a renewable energy generation sources (e.g., photovoltaic array, wind driven micro-turbine) in lieu of grid, line or mains power. Advantageously, the luminaire control system can cause the use of stored energy independent of whether or not grid, line or mains power is available. Thus, the luminaire control system can cause the use of stored energy from the energy storage device, even where power is otherwise available via the grid, line or mains supply or power network. The first signals may be received from an external device. For example, the first signals may be received (e.g., wirelessly via cellular, WI-FI, Bluetooth, infrared) from a remote controller, tablet computer or smartphone executing an application (e.g., processor-executable instructions). Also for example, the first signals may be received (e.g., wiredly via the Internet, an extranet, virtual private network) from a remote computer or other processor-based system executing an application (e.g., processor-executable instructions) and operated by a user or entity (e.g., municipality, landlord, merchant, governmental authority).

At 306, the at least one controller enters into a stored energy consuming mode. The at least one controller may, for example, enter into the stored energy consuming mode in response to receipt of the first signals. Alternatively, the at least one controller may automatically and/or autonomously enter into the stored energy consuming mode in response to some condition or event (e.g. addition of an energy storage device to the system; full charge on an energy storage device, configuration of the system). In some implementations, the at least one controller may always operate in the stored energy consuming mode, barring some abnormality, testing or troubleshooting in which event the at least one controller may enter an appropriate failure, testing or troubleshooting, or debugging mode.

At 308, in the stored energy consuming mode the at least one controller determines whether there is sufficient stored power to power a luminaire through a dusk-to-dawn cycle. As previously noted, the use of stored energy to power the light source(s) of the luminaire may be independent of whether electrical power is available via a line, grid or mains power source. This is in contrast to use of stored power to power lights in the event of a failure of the line, grid or mains power source (e.g., a blackout).

At 310, in the stored energy consuming mode the at least one controller determines whether to apply an illumination adjustment or dimming schedule. For example, the at least one controller may determine whether there is dischargeable and/or rechargeable power source available, and whether such power source has sufficient stored power to power the luminaire over at least a portion of a cycle, for instance over a dusk-to-dawn portion of a daily or diurnal cycle. Various techniques to determining whether to apply an illumination adjustment or dimming scheduled are discussed herein.

In some implementations, there may be more than one illumination adjustment or dimming schedules available. Thus, at 312, in the stored energy consuming mode the at least one controller selects an illumination adjustment or dimming schedule. The at least one controller can select an appropriate illumination adjustment or dimming schedule based on a number of factors or criteria. For example, the at least one controller can select an appropriate illumination adjustment or dimming schedule based on an actual or estimated amount of stored power available via the dischargeable and/or rechargeable power source. Additionally or alternatively, the at least one controller can select an appropriate illumination adjustment or dimming schedule based, for example, on an actual or estimated amount of power required to operate at least the light sources of the luminaire over at least a portion of a cycle, for instance over a dusk-to-dawn portion of a daily or diurnal cycle.

For example, the at least one controller can compare the at least estimated power available to power the luminaire through the dusk-to-dawn cycle to a respective estimated amount of power required to power the luminaire through the dusk-to-dawn cycle for each of a plurality of dimming schedules. In particular, selection of the illumination adjustment or dimming schedule can be based at least in part on the comparison of the at least estimated power available to power the luminaire through the dusk-to-dawn cycle and the respective estimated amount of power required to power the luminaire through the dusk-to-dawn cycle for each of the plurality of illumination adjustment or dimming schedules.

For instance, the at least one controller can select between a more aggressive illumination adjustment or dimming schedule and a less aggressive illumination adjustment or dimming schedule based on a respective actual or estimated amount of power required under each of the illumination adjustment or dimming schedules to operate at least the light sources of the luminaire over at least a portion of a cycle (e.g., a dusk-to-dawn portion of a daily or diurnal cycle). The at least one controller can, for example, select the most aggressive illumination adjustment or dimming schedule that will adequately supply power to the light sources while minimizing the remaining amount of power stored in the dischargeable and/or rechargeable power source. Alternatively, the at least one controller can select a slightly aggressive illumination adjustment or dimming schedule, for instance one that will result in a defined percentage (e.g., 10%, 15%, 25%) of remaining power stored in the dischargeable and/or rechargeable power source. In some implementations, the control system may be powered via the dischargeable and/or rechargeable power source. In such implementations, the at least one controller can include an actual or estimated amount of power required to run the control system in determining an amount of power required, and can select the illumination adjustment or dimming schedule accordingly. In such implementations, it may be advisable to select a less aggressive illumination adjustment or dimming schedule than might otherwise be selected, to ensure that there is always sufficient power to power the control system.

Further, the at least one controller can select the illumination adjustment or dimming schedule further based at least in part on at least one specified condition of illumination to be placed on operation of the luminaire during the dusk-to-dawn cycle. For instance, selection of the illumination adjustment or dimming schedule can be further based at least in part on at least one specified duration of a maximum illumination by the luminaire for a set period of time with respect to a solar event during the dusk-to-dawn cycle inclusive of a dusk event and a dawn event.

At 314, in the stored energy consuming mode the at least one controller executes the selected illumination adjustment or dimming schedule. In particular, the at least one controller can execute instructions that cause the at least one controller to control the light source(s) of one or more luminaires according to conditions and/or parameters specified in the selected illumination adjustment or dimming schedule. Thus, for example, the at least one controller may cause an illumination level or intensity level, or even color temperature, emitted by a light source of the luminaire to adjust downward at some time or point after the light source is initially turned ON during a dusk-to-dawn portion of a daily or diurnal cycle. The time or point for the downward adjustment may be specified in various manners, for instance as a time period (e.g., 1 hour) after turn ON, or as a percentage (e.g., 6%) or fraction (e.g., 1/12) of the total dusk-to-dawn portion of the daily or diurnal cycle after turn ON. Also for example, the at least one controller may cause an illumination level or intensity level, or even color temperature, emitted by a light source of the luminaire to adjust upward at some time or point before the light source is turned OFF during a dusk-to-dawn portion of a daily or diurnal cycle, or alternatively at some time or point after the light source is initially turned ON during a dusk-to-dawn portion of a daily or diurnal cycle. The time or point for the upward adjustment may be specified in various manners, for instance as a time period (e.g., 1 hour) before turn OFF, or as a percentage (e.g., 6%) or fraction (e.g., 1/12) of the total dusk-to-dawn portion of the daily or diurnal cycle before turn OFF.

As discussed herein, one or more illumination adjustment or dimming schedules may include more than one downward, and/or more than one upward adjustments to non-zero illumination levels which are scheduled to occur between the initial turn ON and turn OFF associated with dusk and dawn conditions, respectively. Also, one or more illumination adjustment or dimming schedules may specify turn ON and turn OFF conditions and/or parameters. Further, the at least one controller or other circuitry may implement conventional motion sensing or motion activated operation in conjunction with the illumination adjustment or dimming schedule operation. Thus, for example, the at least one controller or other circuitry may cause the light sources to emit at a maximum illumination level or intensity in response to detection of motion. The at least one controller or other circuitry may cause the light sources to continue to emit at the maximum illumination level or intensity for a defined time after initial detection of motion or after a most recent detection of motion, for instance if motion is detected while still emitting a maximum illumination level or intensity. At the end of the defined time following detection of motion, the at least one controller or other circuitry continues to return to operating the light sources per the selected illumination adjustment or dimming schedule.

At 316, in the stored energy consuming mode the at least one controller operates at least one light of the luminaire according to the illumination adjustment or dimming schedule. In particular, the at least one controller can execute instructions that cause the at least one controller to control a switch or other electrical or electronic component according to conditions and/or parameters specified in the selected illumination adjustment or dimming schedule.

The method 300 terminates at 318, for example until called or invoked again. Alternatively, the method 300 may repeat until actively terminated.

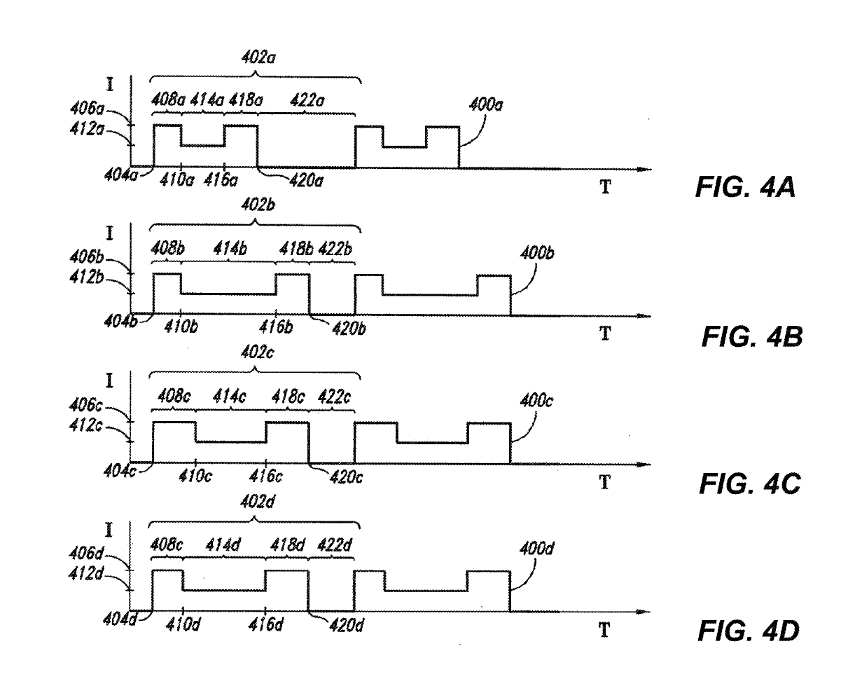

FIG. 4A shows a graph 400a of a level of light produced by a light source over time during a first part of a year, according to one non-limiting illustrated embodiment.

In particular, the level of light output by the light source is shown along the Y-axis, while time is shown along the X-axis. In a first daily cycle 402a, the light source is turned ON at 404a to produce light at a first level (e.g., relatively high) 406a for a first duration 408a. The level of light produced by the light source is then adjusted at 410a to produce a lower level 412a of light for a second duration 414a. The level of light produced is then adjusted at 416a to produce a higher level 406a of light for a third duration 418a. While illustrated as equal to the level 406a of the first duration 408a, the level 406a of the third duration 418a may be greater or less than the level 406a during the first duration 408a. The light source is then turned OFF at 420a for a fourth duration 422a during the daily cycle 402a. As illustrated, this repeats for additional daily cycles, although the length of the various durations may gradually change, for example as the amount of daylight during the daily cycle changes.

FIG. 4B shows a graph 400b of a level of light produced by a light source over time during a first part of a year, according to one non-limiting illustrated embodiment.

Times or durations corresponding to those of FIG. 4A are called out using the same reference numerals but with the lower case letter “b” instead of the lower case letter “a” used in FIG. 4A. The pattern is similar to that illustrated in FIG. 4A, however the second duration 414b at the lower level 412b is longer than that illustrated in FIG. 4A. Such is in response to the amount of daylight in the daily cycle 402b being shorter that that illustrated in FIG. 4A. Thus, FIG. 4A may represent summer in the Northern Hemisphere, while FIG. 4B may represent winter in the same location.

FIG. 4C shows a graph 400c of a level of light produced by a light source over time during a first part of a year, according to one non-limiting illustrated embodiment.

Times or durations corresponding to those of FIGS. 4A and 4B are called out using the same reference numerals but with the lower case letter “c” instead of the lower case letter “a” or “b” used in FIGS. 4A and 4B, respectively. The pattern is similar to that illustrated in FIG. 4B, however the first and third durations 408c, 418c at the high level 406c are longer than that illustrated in FIG. 4B. Such durations 408c, 418c may be factory set or may be user configurable, set based on user input received via a user interface (e.g., buttons, switches, dials, potentiometers, shorting jumpers, wired or wireless communications ports, or via power line carrier control) of the luminaire. Such user input may, for instance, indicate a fixed time for the first and third durations or may indicate percentages of the total period that the light source is turned ON that should be apportioned to the first and third durations.

FIG. 4D shows a graph 400d of a level of light produced by a light source over time during a first part of a year, according to one non-limiting illustrated embodiment.

Times or durations corresponding to those of FIGS. 4A-4C are called out using the same reference numerals but with the lower case letter “d” instead of the lower case letter “a” “b” or “c” used in FIGS. 4A-4C, respectively. The pattern is similar to that illustrated in FIG. 4C, however the first and third durations 408d, 418d are of unequal lengths with respect to one another. As previously noted, such durations 408d, 418d may be user configurable, set based on user input received via a user interface (e.g., buttons, switches, dials, communications port) of the luminaire.

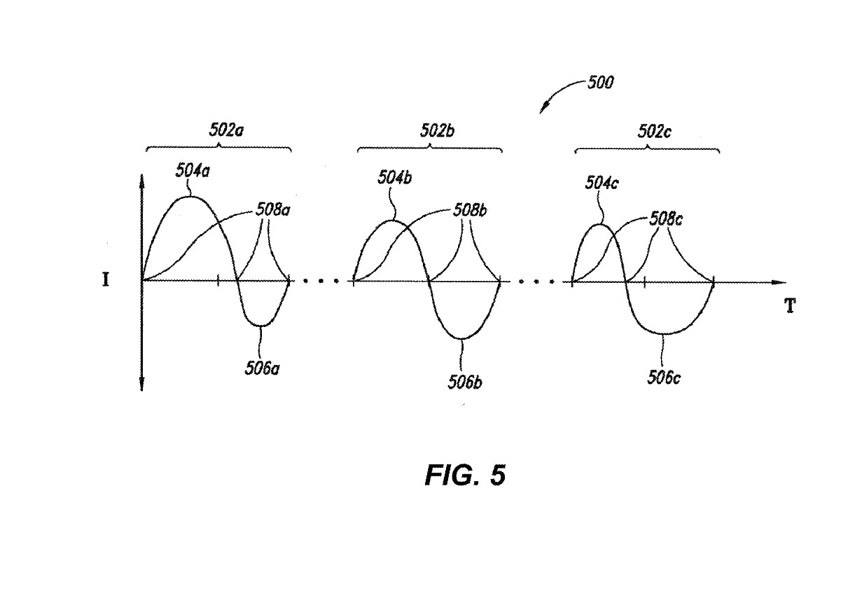

FIG. 5 shows a graph of a level of light or illumination 500 produced by the sun at a location over time during a number of daily cycles 502a-502c (collectively 502) over a period of time such as a year.

The level of solar insolation over a daily cycle 502 varies approximately as a sinusoidal curve. While the length of any given daily cycle 502 is approximately 24 hours, the amount of daylight and nighttime vary inversely with one another. Depending on the latitude of the location, this variation may be relatively small or nonexistent, for instance proximate the Equator, or may be relatively large, for instance at or proximate the Poles.

In the illustrated example, a first daily cycle 502a has a relatively long amount of daylight relative to nighttime, and a relatively high maximum level of solar insolation 504a, corresponding to solar noon. Solar midnight occurs at a minimum level of solar insolation 506a. Thus, the first daily cycle 502a may, for instance, represent a daily cycle occurring during the Summer in the Northern or Southern Hemispheres. A maximum rate of change 508a in the level of light or illumination occurs at the zero crossing, while a minimum rate of change (not called out) occurs at the maximum and minimum levels. The direction of level (e.g., increasing or decreasing) can also easily be discerned in FIG. 5. In the illustrated example, a second daily cycle 502b has a relatively long amount of daylight relative to nighttime, and a relatively high maximum level of solar insolation 504b, corresponding to solar noon. Solar midnight occurs at a minimum level of solar insolation 506b. Thus, the first daily cycle 502b may, for instance, represent a daily cycle occurring during the Spring or Fall in the Northern or Southern Hemispheres. A maximum rate of change 508b in the level of light or illumination occurs at the zero crossing, while a minimum rate of change (not called out) occurs at the maximum and minimum levels.

In the illustrated example, a second daily cycle 502c has a relatively long amount of daylight relative to nighttime, and a relatively high maximum level of solar insolation 504c, corresponding to solar noon. Solar midnight occurs at a minimum level of solar insolation 506c. Thus, the first daily cycle 502c may, for instance, represent a daily cycle occurring during the Winter in the Northern or the Summer in the Southern Hemispheres. A maximum rate of change 508c in the level of light or illumination occurs at the zero crossing, while a minimum rate of change (not called out) occurs at the maximum and minimum levels.

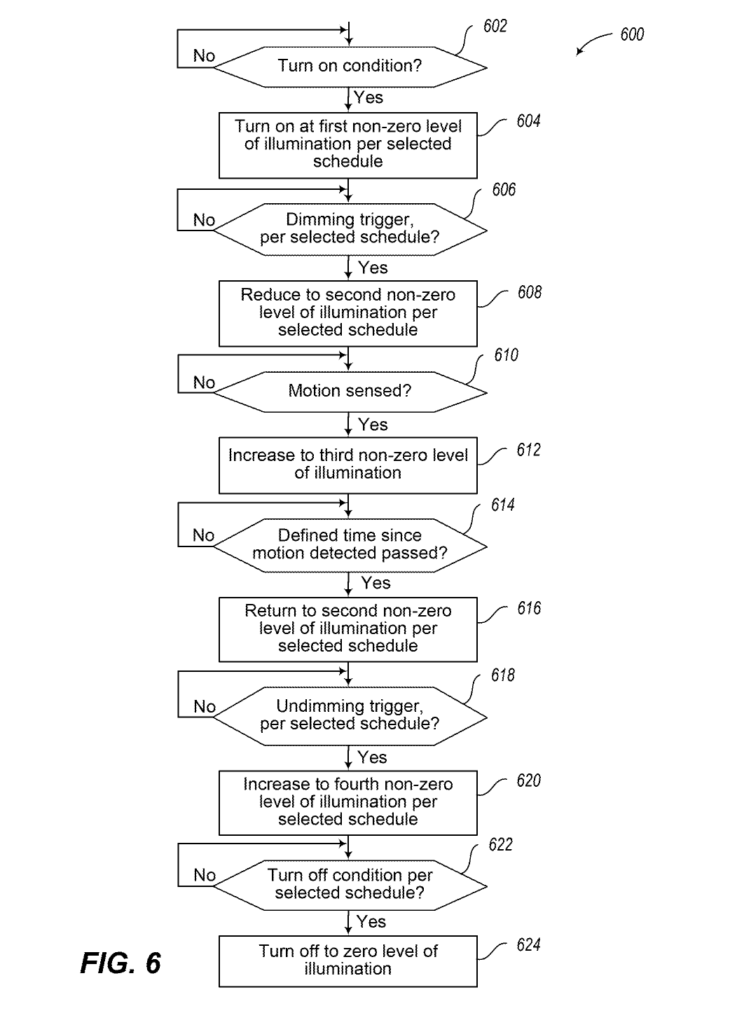

FIG. 6 shows a method 600 of operation in a luminaire control system to control operation of a luminaire, according to one illustrated embodiment. The method 600 employs an illumination adjustment or dimming schedule that specifies at least one of turn ON and/turn OFF information, in addition to downward and upward adjustments of illumination between turn ON and turn OFF. The method 600 can, for example, be executed as part of execution of the method 300 (FIG. 3), for example in executing an illumination adjustment or dimming schedule 314 (FIG. 3) and/or operating at least one luminaire via a dischargeable and/or rechargeable energy storage device according to an illumination adjustment or dimming schedule 316 (FIG. 3).

At 602, a control system or a component thereof (e.g., at least one processor of the control system) determines whether a turn ON condition has occurred. For example, at least one processor or other circuitry may determine whether a level of illumination in an ambient environment in which the luminaire is located is below a turn ON threshold, for instance a turn ON threshold indicative of dusk. The at least one processor or other circuitry may employ signals from an ambient light sensor or dusk/dawn sensor (e.g., photodiode).

The ambient light sensor or dusk/dawn sensor may be part of the luminaire or may have been installed with the luminaire which constitutes a legacy device or legacy system, as compared to the control system. The control system may, on the other hand, constitute a retrofit system, installed after the installation of the luminaire and/or installation of the ambient light sensor or dusk/dawn sensor. The control system may, for example, have been installed along with a dischargeable and/or rechargeable energy storage device and/or renewable power generation device (e.g., photovoltaic array, wind powered micro-turbine).

At 604, in response to a determination that a turn ON condition has occurred, the at least one processor causes at least one light source of at least one luminaire to turn ON at first non-zero level of illumination, per the selected illumination adjustment or dimming schedule. For example, the at least one processor can cause the light source(s) of the luminaire(s) to turn ON at a maximum or near maximum level of illumination (e.g., within a operational defined threshold of the maximum level of illumination).

At 606, the at least one processor monitors for an occurrence of a dimming trigger, the dimming trigger specified by the illumination adjustment or dimming schedule, for example specified by a selected illumination adjustment or dimming schedule. For instance, the at least one processor can monitor for occurrence of a defined event after or following the turn ON event. For example, the at least one processor can monitor for occurrence of a passage of a defined duration after the turn ON event. The defined duration may be specified by the illumination adjustment or dimming schedule, for example in terms of seconds, minutes, hours, percentage or fraction of total dusk-to-dawn cycle, or clock cycles of a timer or clock following the turn ON event. Also for example, the at least one processor can monitor for occurrence of a defined time (e.g., real world time) or condition (e.g., solar midnight, solar noon, midway between solar midnight and solar noon).

At 608, in response to the dimming trigger the at least one processor causes the light emitted or produced by the light source(s) of the luminaire(s) to be reduced to a second non-zero level of illumination, as specified by the illumination adjustment or dimming schedule, for example as specified by a selected illumination adjustment or dimming schedule.

At 610, the at least one processor or other circuitry (e.g., motion sensor) determines whether motion is sensed. In the method 600 the motion sensing may operate concurrently during a portion or all of the remainder of the method, for example as a parallel routine or thread. As noted, the motion sensing may be performed by the at least one processor of a retrofit luminaire control system, or may be performed by a motion sensor which is a legacy component of the luminaire. The motion sensing may rely on signals from a passive infrared (PIR) image sensor or a non-PIR image sensor (e.g., camera with detection of frame-to-frame differences in captured images).

At 612, in response to a determination that motion has been sensed, the at least one processor causes the light emitted or produced by the light source(s) of the luminaire(s) to be increased to a third non-zero level of illumination, as specified by the illumination adjustment or dimming schedule, for example as specified by a selected illumination adjustment or dimming schedule. The at least one processor can, for example, control a switch, relay or other electrical or electronic component, either directly or indirectly, to adjust the illumination level. For instance, the at least one processor can directly or indirectly adjust: i) a duty cycle of a pulse width modulated wave form, ii) a voltage, and/or iii) a current, or a number of light sources which are active at any given time. The third non-zero level of illumination can be the same as some other non-zero level, for instance the same as the first non-zero level of illumination (e.g., maximum or bright level).

At 614, the at least one processor monitors for passage of a defined time after motion was last sensed. For example, the at least one processor may set a timer on occurrence of each detection of motion, and check to set if the timer has counted down or reached a defined value.

At 616, in response the passage of a defined time after motion was last sensed, at least one processor causes the light source(s) of the luminary to return to the second non-zero level of illumination, per the selected schedule, for example a dimmed level of illumination.

At 618, the at least one processor monitors for occurrence of another trigger, denominated as an undimming trigger, the undimming trigger specified by the illumination adjustment or dimming schedule, for example specified by a selected illumination adjustment or dimming schedule. For instance, the at least one processor can monitor for occurrence of a defined event that either precedes a turn OFF event or that follows the turn ON event. For example, the at least one processor can monitor for occurrence of a period of time which precedes the turn OFF event. The defined period of may be specified by the illumination adjustment or dimming schedule, for example in terms of seconds, minutes, hours, percentage or fraction of total dusk-to-dawn cycle, or clock cycles of a timer or clock before the turn OFF event. The time for the turn OFF event can, for instance, be predicted or estimated using the time of the occurrence of the turn OFF event on one or more preceding days or daily cycles. Also for example, the at least one processor can monitor for occurrence of a defined time (e.g., real world time) or condition (e.g., solar midnight, solar noon, midway between solar midnight and solar noon).

At 620, in response to the illumination adjustment or undimming trigger the at least one processor causes the light emitted or produced by the light source(s) of the luminaire(s) to be increased to a fourth non-zero level of illumination, as specified by the illumination adjustment or dimming schedule, for example as specified by a selected illumination adjustment or dimming schedule. The at least one processor can, for example, control a switch, relay or other electrical or electronic component, either directly or indirectly, to adjust the illumination level. For instance, the at least one processor can directly or indirectly adjust: i) a duty cycle of a pulse width modulated wave form, ii) a voltage, and/or iii) a current, or a number of light sources which are active at any given time. The fourth non-zero level of illumination can be same as some other non-zero level, for instance the same as the first non-zero level of illumination.

At 622, the control system or a component thereof (e.g., at least one processor of the control system) determines whether a turn OFF condition has occurred. For example, at least one processor or other circuitry may determine whether a level of illumination in an ambient environment in which the luminaire is located is above a turn OFF threshold, for instance a turn OFF threshold indicative of dawn. The at least one processor or other circuitry may employ signals from an ambient light sensor or dusk/dawn sensor (e.g., photodiode). The turn OFF threshold may be different from the turn ON threshold, or alternatively the turn OFF threshold may be the same as the turn ON threshold.

At 624, in response to a determination that a turn OFF condition has occurred, the at least one processor causes at least one light source of at least one luminaire to turn OFF to a zero level of illumination, per the selected illumination adjustment or dimming schedule. For example, the at least one processor can cause the light source(s) of the luminaire(s) to turn OFF.

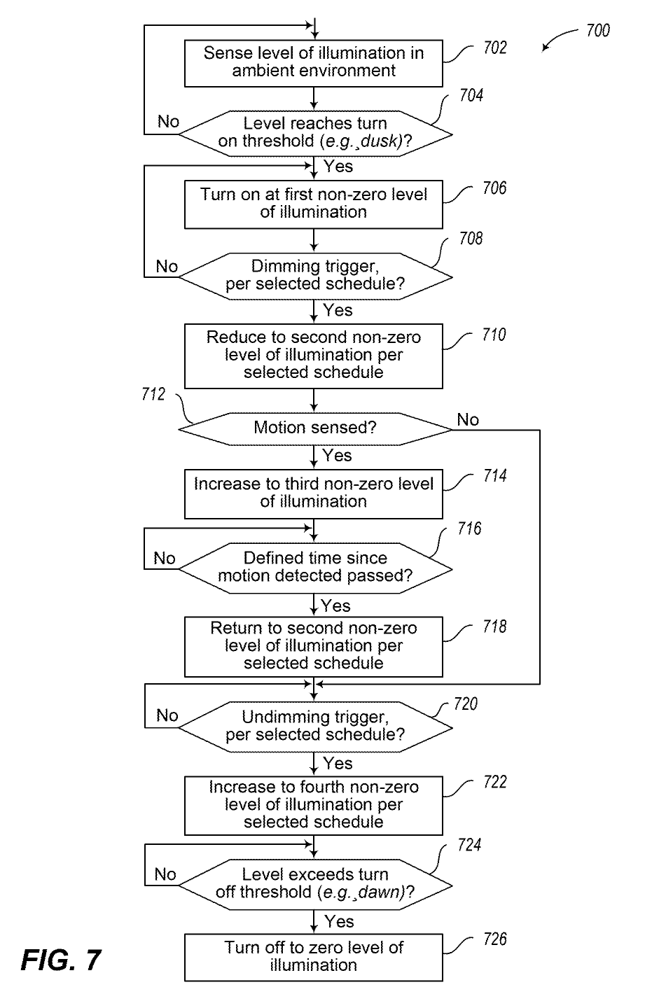

FIG. 7 shows a method 700 of operation in a luminaire control system to control operation of a luminaire, according to one illustrated embodiment. In contrast to the method 600, the method 700 employs an illumination adjustment or dimming schedule that specifies downward and upward adjustments of illumination between turn ON and turn OFF, but does not specify turn ON and/turn OFF information. The method 700 can, for example, be executed as part of execution of the method 300 (FIG. 3) for example in executing an illumination adjustment or dimming schedule 314 (FIG. 3) and/or operating at least one luminaire via a dischargeable and/or rechargeable energy storage device according to an illumination adjustment or dimming schedule 316 (FIG. 3).

At 702, an ambient light sensor or dusk/dawn sensor (e.g., photodiode) senses a level of illumination in an ambient environment in which the luminaire is located.

At 704, circuitry of the dusk/dawn sensor or the control system or a component thereof (e.g., at least one processor of the control system) determines whether a turn ON condition has occurred, e.g., the sensed level of illumination in the ambient environment reaches a turn ON threshold (e.g. less than or equal to a level that indicates dusk). The turn ON threshold may be user specified. For instance, a user may specify the turn ON threshold by adjusting a dial or button or keys on the luminaire or on a dusk/dawn sensor associated with the luminaire, which may be legacy device. Alternatively, a user may specify the turn ON threshold by causing a processor-based device (e.g., remote control, tablet computing device, smartphone) to transmit information to the dusk/dawn sensor or control system.

At 706, in response to a determination that a turn ON condition has occurred, the circuitry of the dusk/dawn sensor or the control system or a component thereof (e.g., at least one processor of the control system) causes at least one light source of at least one luminaire to turn ON at first non-zero level of illumination. For example, the at least one processor can cause the light source(s) of the luminaire(s) to turn ON at a maximum or near maximum level of illumination (e.g., within a operational defined threshold of the maximum level of illumination).

At 708, the at least one processor monitors for an occurrence of a dimming trigger, the dimming trigger specified by the illumination adjustment or dimming schedule, for example specified by a selected illumination adjustment or dimming schedule. For instance, the at least one processor can monitor for occurrence of a defined event after or following the turn ON event. For example, the at least one processor can monitor for occurrence of a passage of a defined duration after the turn ON event. The defined duration may be specified by the illumination adjustment or dimming schedule, for example in terms of seconds, minutes, hours, percentage or fraction of total dusk-to-dawn cycle, or clock cycles of a timer or clock following the turn ON event. Also for example, the at least one processor can monitor for occurrence of a defined time (e.g., real world time) or condition (e.g., solar midnight, solar noon, midway between solar midnight and solar noon).

At 710, in response to the dimming trigger the at least one processor causes the light emitted or produced by the light source(s) of the luminaire(s) to be reduced to a second non-zero level of illumination, as specified by the illumination adjustment or dimming schedule, for example as specified by a selected illumination adjustment or dimming schedule.

At 712, the circuitry of the dusk/dawn sensor or the control system or a component thereof (e.g., at least one processor of the control system) determines whether motion is sensed. In the method 700 the motion sensing may operate concurrently during a portion or all of the remainder of the method, for example as a parallel routine or thread, for example executed by the legacy motion sensor in parallel with the retrofit control system. As noted, the motion sensing may be performed by the at least one processor of a retrofit luminaire control system, or may be performed by a motion sensor which is a legacy component of the luminaire. The motion sensing may rely on signals from a passive infrared (PIR) image sensor or a non-PIR image sensor (e.g., camera with detection of frame-to-frame differences in captured images).

At 714, in response to a determination that motion has been sensed, the circuitry of the dusk/dawn sensor or the control system or a component thereof (e.g., at least one processor of the control system) causes the light emitted or produced by the light source(s) of the luminaire(s) to be increased to a third non-zero level of illumination, as specified by the illumination adjustment or dimming schedule, for example as specified by a selected illumination adjustment or dimming schedule. The circuitry of the dusk/dawn sensor or the control system or a component thereof (e.g., at least one processor of the control system) can, for example, control a switch, relay or other electrical or electronic component, either directly or indirectly, to adjust the illumination level. For instance, the circuitry of the dusk/dawn sensor or the control system or a component thereof (e.g., at least one processor of the control system) can directly or indirectly adjust: i) a duty cycle of a pulse width modulated wave form, ii) a voltage, and/or iii) a current, or a number of light sources which are active at any given time. The third non-zero level of illumination can be the same as some other non-zero level, for instance the same as the first non-zero level of illumination (e.g., maximum or bright level).

At 716, the circuitry of the dusk/dawn sensor or the control system or a component thereof (e.g., at least one processor of the control system) monitors for passage of a defined time after motion was last sensed. For example, the circuitry of the dusk/dawn sensor or the control system or a component thereof (e.g., at least one processor of the control system) may set a timer on occurrence of each detection of motion, and check to set if the timer has counted down or reached a defined value.

At 718, in response the passage of a defined time after motion was last sensed, the circuitry of the dusk/dawn sensor or the control system or a component thereof (e.g., at least one processor of the control system) causes the light source(s) of the luminary to return to the second non-zero level of illumination, per the selected schedule, for example a dimmed level of illumination.

At 720, the at least one processor monitors for occurrence of another trigger, denominated as an undimming trigger, the undimming trigger specified by the illumination adjustment or dimming schedule, for example specified by a selected illumination adjustment or dimming schedule. For instance, the at least one processor can monitor for occurrence of a defined event that either precedes a turn OFF event or that follows the turn ON event. For example, the at least one processor can monitor for occurrence of a period of time which precedes the turn OFF event. The defined period of may be specified by the illumination adjustment or dimming schedule, for example in terms of seconds, minutes, hours, percentage or fraction of total dusk-to-dawn cycle, or clock cycles of a timer or clock before the turn OFF event. The time for the turn OFF event can, for instance, be predicted or estimated using the time of the occurrence of turn OFF event on one or more preceding days or daily cycles. Also for example, the at least one processor can monitor for occurrence of a defined time (e.g., real world time) or condition (e.g., solar midnight, solar noon, midway between solar midnight and solar noon).

At 722, in response to the illumination adjustment or undimming trigger the at least one processor causes the light emitted or produced by the light source(s) of the luminaire(s) to be increased to a fourth non-zero level of illumination, as specified by the illumination adjustment or dimming schedule, for example as specified by a selected illumination adjustment or dimming schedule. The at least one processor can, for example, control a switch, relay or other electrical or electronic component, either directly or indirectly, to adjust the illumination level. For instance, the at least one processor can directly or indirectly adjust: i) a duty cycle of a pulse width modulated wave form, ii) a voltage, and/or iii) a current, or a number of light sources which are active at any given time. The fourth non-zero level of illumination can be the same as some other non-zero level, for instance the same as the first non-zero level of illumination.

At 724, the control system or a component thereof (e.g., at least one processor of the control system) determines whether a turn OFF condition has occurred. For example, at least one processor or other circuitry may determine whether a level of illumination in an ambient environment in which the luminaire is located is above a turn OFF threshold, for instance a turn OFF threshold indicative of dawn. The at least one processor or other circuitry may employ signals from an ambient light sensor or dusk/dawn sensor (e.g., photodiode). The turn OFF threshold may be different from the turn ON threshold, or alternatively the turn OFF threshold may be the same as the turn ON threshold.

At 726, in response to a determination that a turn OFF condition has occurred, the at least one processor causes at least one light source of at least one luminaire to turn OFF to a zero level of illumination, per the selected illumination adjustment or dimming schedule. For example, the at least one processor can cause the light source(s) of the luminaire(s) to turn OFF.

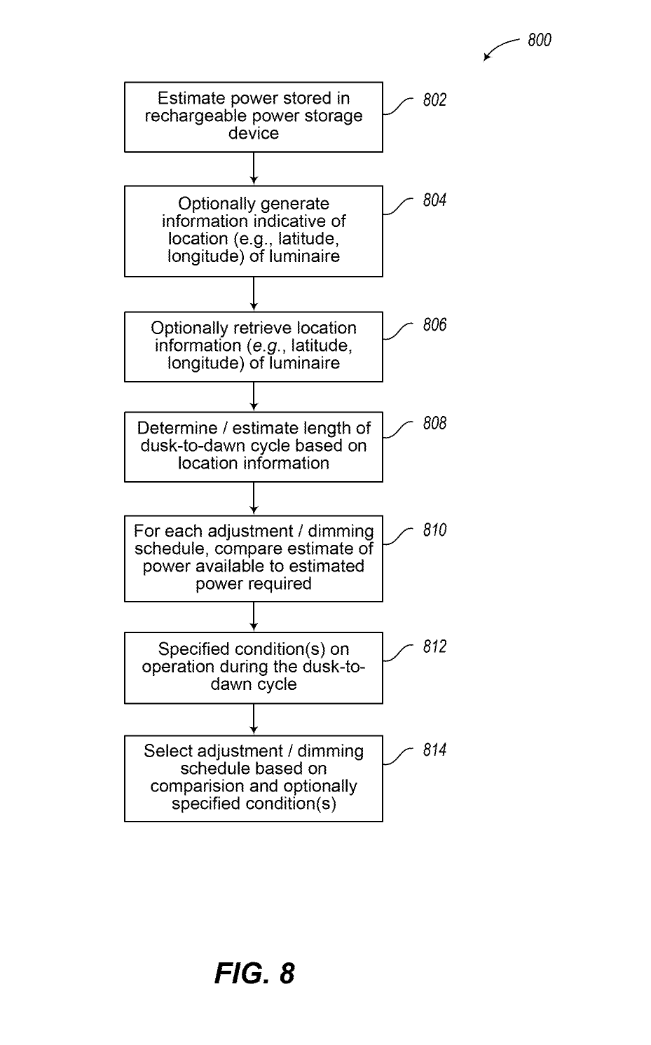

FIG. 8 shows a method 800 of operation in a luminaire control system to control operation of a luminaire, according to one illustrated embodiment. The method 800 can, for example, be executed as part of execution of the method 300 (FIG. 3) for example in determining whether there is sufficient stored power to operate a luminaire through a dusk-to-dawn cycle 308, determining whether to apply an illumination adjustment or dimming schedule 310 (FIG. 3) and/or selecting an illumination adjustment or dimming schedule 312 (FIG. 3).

At 802, the control system or a component thereof (e.g., at least one processor of the control system) at least estimates (i.e., determines, calculates the actual or at least an estimate of) an amount of power stored in the dischargeable and/or rechargeable power storage device. As discussed herein, various techniques can be employed. In some implementations, a measure of stored power may be directly available from the dischargeable and/or rechargeable power storage device, for example from an array of secondary battery cells or an array of super-capacitor cells, or from a charging circuit or charger. More typically, such direct measures may not be available, for example where one or more components are a retrofit to legacy equipment. In such implementations, other measurements may be used as a proxy for stored power. For example, a measurement of solar insolation may be used as a proxy for stored power where, for instance, the dischargeable and/or rechargeable power storage device is recharged via a photovoltaic array. The measurement of solar insolation may be derived from a variety of sources, for instance from a dusk-to-dawn sensor and/or a motion sensor, which may for instance form part of a legacy luminaire or luminaire installation. Alternatively, one or more light sensors (e.g., photodiodes) may be installed as part of a retrofit to a legacy luminaire or luminaire installation, or a measurement of solar insolation may be derived from a photovoltaic array that is used to recharge the dischargeable and/or rechargeable power storage device.

Optionally at 804, the control system or a component thereof (e.g., at least one processor of the control system) generates information indicative of a location (e.g., latitude, longitude) 245 of a luminaire. For example, the control system may include one or more global positioning receivers, or have access to information from one or more global positioning receivers, for instance global positioning receivers for the U.S. Global Positioning System (GPS), the Russian Globalnaya Navigatsionnaya Sputnikovaya Sistema (GLOSNASS) global positioning system and/or Europe's Galileo global positioning system. Additionally or alternatively, the control system may include one or more cellular communications receivers or radios that provide for position tracking or obtaining position information. Additionally or alternatively, the control system may include one or more WI-FI receivers or radios that provide for position tracking or obtaining position information.

Optionally at 806, the control system or a component thereof (e.g., at least one processor of the control system) retrieves location information 245 (e.g., latitude, longitude) of a luminaire, for example location information stored in one or more nontransitory storage media of the control system. The location information 245 may, for example, be programmed into the nontransitory storage media of the control system during installation of the luminaire at the location, or afterwards. The location information 245 may, for example, be programmed into the nontransitory storage media via wireless signals, for example sent via a processor-based device, for instance a handheld remote control, tablet computer or smartphone. Alternatively, the location information 245 may, for example, be programmed into the nontransitory storage media via wired signals, for example sent via a wired network from a remote, central location. In some instances, a combination of wired and wireless communications may be employed to store location information 245. Additionally or alternatively, the location information 245 may be derived by a global positioning receiver or radio in a handheld device, and provided (e.g., wirelessly or wiredly) to the control system via one or more communications ports to be stored in, and later retrieved from, the nontransitory storage media of the control system.

At 808, the control system or a component thereof (e.g., at least one processor of the control system) determines or estimates a length of dusk-to-dawn cycle based on location information.

At 810, for each of a number of illumination adjustment or dimming schedules stored in at least one nontransitory storage medium (e.g., Flash memory), the control system or a component thereof (e.g., at least one processor of the control system) compares the at least an estimate of the available stored power to a respective one of the at least estimated power required to power the at least one luminaire under the respective illumination adjustment or dimming schedule.

At 812, the control system or a component thereof (e.g., at least one processor of the control system) determines whether there are specified condition(s) placed on the operation of the luminaire during the dusk-to-dawn cycle.

At 814, if there are specified conditions, the control system or a component thereof (e.g., at least one processor of the control system) selects an illumination adjustment or dimming schedule based on comparison and optionally based on specified condition(s). If there are no specified conditions, the control system or a component thereof (e.g., at least one processor of the control system) selects an illumination adjustment or dimming schedule based on comparison.

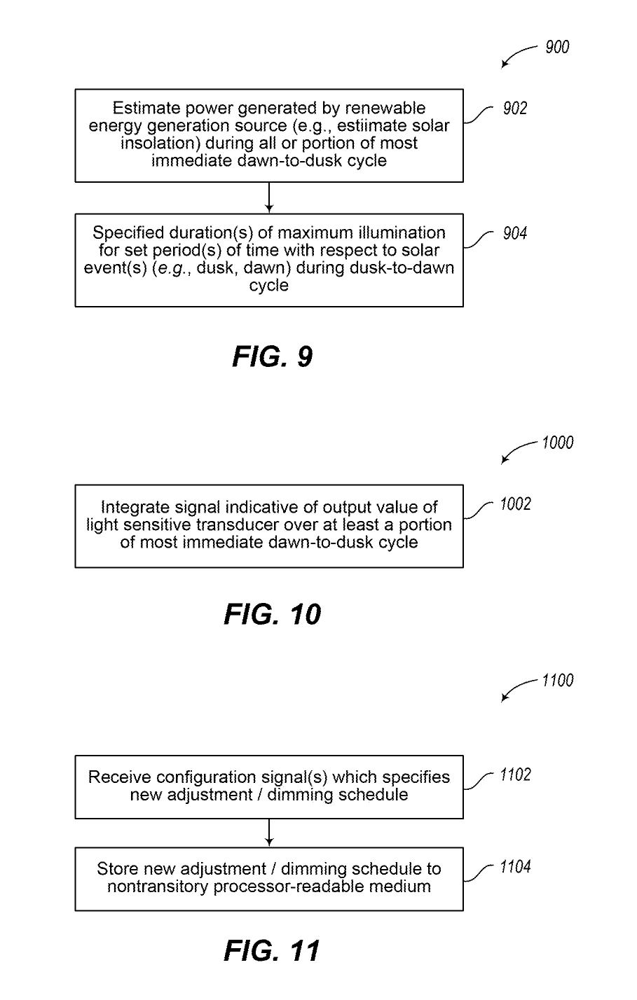

FIG. 9 shows a method 900 of operation in a luminaire control system to control operation of a luminaire, according to one illustrated embodiment. The method 900 can, for example, be executed as part of execution of the method 800 (FIG. 8) for example in preparation to selecting a suitable illumination adjustment or dimming schedule.

In order to estimate an amount of power stored in the dischargeable and/or rechargeable power storage device, the control system or a component thereof (e.g., at least one processor of the control system) determines or estimates an amount of power generated by a renewable energy generation source (e.g., estimate solar insolation) during all or portion of a most immediate dawn-to-dusk cycle at 902.

As discussed herein, various techniques can be employed. In some implementations, a measure of stored power may be directly available from the dischargeable and/or rechargeable power storage device, for example from an array of secondary battery cells or an array of super-capacitor cells, or from a charging circuit or charger. More typically, such direct measures may not be available, for example where one or more components are a retrofit to legacy equipment. In such implementations, other measurements and/or estimates may be used as a proxy for stored power. For example, a measurement of solar insolation may be used as a proxy for stored power where, for instance, the dischargeable and/or rechargeable power storage device is recharged via a photovoltaic array. The measurement of solar insolation may be derived from a variety of sources, for instance from a dusk-to-dawn sensor and/or a motion sensor, which may for instance form part of a legacy luminaire or luminaire installation. Alternatively, one or more light sensors (e.g., photodiodes) may be installed as part of a retrofit to a legacy luminaire or luminaire installation, or a measurement of solar insolation may be derived from a photovoltaic array that is used to recharge the dischargeable and/or rechargeable power storage device.

The at least one processor may, for example, take into account a drain on the dischargeable and/or rechargeable power storage device during the cycle, or portion thereof, that is of interest. For example, the at least one processor may account for power used to run the control subsystem where the control subsystem is powered either directly by the renewable energy generation source or by the dischargeable and/or rechargeable power storage device. Additionally or alternatively, the at least one processor may, for example, take into account inefficiencies in the process, for example inefficiency in converting solar insolation into electrical power, and in storing and/or retrieving electrical power from the dischargeable and/or rechargeable power storage device.

At 904, the at least one processor can determine and/or account for any specified duration(s) of maximum illumination for set period(s) of time with respect to solar event(s) (e.g., dusk, dawn) during a dusk-to-dawn cycle. Operation at or near maximum power can place a significant burden on the stored power, so the at least one processor may account for such.

FIG. 10 shows a method 1000 of operation in a luminaire control system to control operation of a luminaire, according to one illustrated embodiment. The method 1000 can, for example, be executed as part of execution of the method 900 (FIG. 9), for example estimating an amount of power generated by a renewable energy generation source 902 (FIG. 9), and hence estimate an amount of stored powered available to operate the luminaire through at least one dusk-to-dawn cycle.

At 1002, the at least one processor integrates a signal indicative of output value of one or more light sensitive transducers over at least a portion of a most immediate dawn-to-dusk cycle. The light sensitive transducer(s) may take a variety of forms. For example, signals may come from a dusk-to-dawn sensor and/or a motion sensor (e.g., non-PIR motion sensor), which may for instance form part of a legacy luminaire or luminaire installation. Alternatively, one or more light sensors (e.g., photodiodes) may be installed as part of a retrofit to a legacy luminaire or luminaire installation, or a measurement of solar insolation may even be derived directly from a photovoltaic array that is used to recharge the dischargeable and/or rechargeable power storage device.

FIG. 11 shows a method 1100 of operation in a luminaire control system to control operation of a luminaire, according to one illustrated embodiment. The method 1100 can, for example, be executed in addition to the method 300 (FIG. 3) to configure the control system to control one or more luminaires.

At 1102, the control system or a component thereof (e.g., at least one processor of the control system) receives configuration signal(s) via one or more communications ports. The received signals can specify a new illumination adjustment or dimming schedule to be added to the control system. Signals may be received via a handheld device, for instance a remote control, tablet computer, or smartphone. Alternatively, signals may be received from some remote processor-based device via a telecommunications network, for instance the Internet, an extranet, a virtual private network.

At 1104, the control system or a component thereof stores the new illumination adjustment or dimming schedule to one or more nontransitory processor-readable media. The control system may add the new illumination adjustment or dimming schedule, or may replace a previous illumination adjustment or dimming schedule with the new illumination adjustment or dimming schedule.

The above description of illustrated embodiments, including what is described in the Abstract, is not intended to be exhaustive or to limit the embodiments to the precise forms disclosed. Although specific embodiments and examples are described herein for illustrative purposes, various equivalent modifications can be made without departing from the spirit and scope of the disclosure, as will be recognized by those skilled in the relevant art. The teachings provided herein of the various embodiments can be applied to other contexts, not necessarily the exemplary context of controlling operations of an illumination system generally described above.

For example, while the illumination systems are generally described above as embodied in a luminaire, the control subsystem may control multiple luminaires. As used herein and in the claims, luminaire is used in its broadest sense to refer to any lighting fixture or structure. While a single step adjustment downward and upward in the level of illumination has been described and illustrated, illumination level may be adjusted in multiple steps, or even continuously to gradually ramp downward some time after turning ON the light source, then eventually back upward some time before turning OFF the light source. Additionally, or alternatively, the embodiments described herein may be combined with motion or proximity detecting, either as implemented by a luminaire control mechanism or by a retrofit or integral control subsystem.

The microcontroller 314, 514 may be programmable and may include one or more input ports (not illustrated) through which a user can program the microcontroller 314, 514. For example, the time delays and the various illumination levels of the light source may be programmed. The input port may include switches and/or potentiometers that can be set to program the microcontroller 314, 514. Alternatively, the input port may include an electrical interface for the user to remotely program the microcontroller 314, 514, whether through a wire or wirelessly. In one embodiment, the input port may be the ambient light sensor which is connected to the microcontroller 314, 514. In one embodiment, the microcontroller 314, 514 is programmable optically via one or more images captured by an image capture device or imager (not illustrated). In one embodiment, printed barcode pages are used to set delay times and other parameters used by the microcontroller 314, 514. The microcontroller 314, 514 may also receive a one-bit input via the input port to activate or deactivate the light source. For example, a binary bit of “0” turns OFF the light source 110 and a binary bit of “1” turns ON the light source.

Also for example, the control subsystem 312, 512 may further include a communication device (not illustrated). The communication device may be communicatively coupled to the microcontroller 314, 514. The communication device may be further coupled to an external data network using protocols in compliance with any or all of the Ethernet, the RS-485 and wireless communication standards, such as the IEEE 802.11 standards for example, or commercially or proprietary power line carrier control standards. The communication device may be used to remotely program the microcontroller 314, 514. Alternatively, the communication device may be used to transmit information from the control subsystem 312, 512 to a remote user or processor based system. For example, the communication device may be used to transmit a notification signal from the microcontroller 314, 514 indicative of turning ON, turning OFF, increasing or decreasing output from a light source. The communication device may be used to transmit an actuation signal from the microcontroller 314, 514 to actuate a device such as an alarm or an automatic door.

Also for example, the various methods may include additional acts, omit some acts, and may perform the acts in a different order than set out in the various flow diagrams. The use of ordinals such as first, second and third, do not necessarily imply a ranked sense of order, but rather may only distinguish between multiple instances of an act or structure.

Also for example, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via one or more microcontrollers. However, those skilled in the art will recognize that the embodiments disclosed herein, in whole or in part, can be equivalently implemented in standard integrated circuits (e.g., Application Specific Integrated Circuits or ASICs), as one or more computer programs executed by one or more computers (e.g., as one or more programs running on one or more computer systems), as one or more programs executed by one or more controllers (e.g., microcontrollers) as one or more programs executed by one or more processors (e.g., microprocessors), as firmware, or as virtually any combination thereof, and that designing the circuitry and/or writing the code for the software and/or firmware would be well within the skill of one of ordinary skill in the art in light of the teachings of this disclosure.

When logic is implemented as software and stored in memory, logic or information can be stored on any computer-readable medium for use by or in connection with any processor-related system or method. In the context of this disclosure, a memory is a computer-readable storage medium that is an electronic, magnetic, optical, or other physical device or means that non-transitorily contains or stores a computer and/or processor program. Logic and/or the information can be embodied in any computer-readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this specification, a “computer-readable medium” can be any element that can store the program associated with logic and/or information for use by or in connection with the instruction execution system, apparatus, and/or device. The computer-readable medium can be, for example, but is not limited to, an electronic, magnetic, optical, electromagnetic, infrared, or semiconductor system, apparatus or device. More specific examples (a non-exhaustive list) of the computer readable medium would include the following: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), and digital tape.

The various implementations described above can be combined to provide further implementations. To the extent that they are not inconsistent with the specific teachings and definitions herein, all of the U.S. patents, U.S. patent application publications, U.S. patent applications, foreign patents, foreign patent applications and non-patent publications referred to in this specification, including but not limited to U.S. Provisional Patent Application No. 61/052,924, filed May 13, 2008; U.S. Pat. No. 8,926,138, issued Jan. 6, 2015; PCT Publication No. WO2009/140141, published Nov. 19, 2009; U.S. Provisional Patent Application No. 61/051,619, filed May 8, 2008; U.S. Pat. No. 8,118,456, issued Feb. 21, 2012; PCT Publication No. WO2009/137696, published Nov. 12, 2009; U.S. Provisional Patent Application No. 61/088,651, filed Aug. 13, 2008; U.S. Pat. No. 8,334,640, issued Dec. 18, 2012; U.S. Provisional Patent Application No. 61/115,438, filed Nov. 17, 2008; U.S. Provisional Patent Application No. 61/154,619, filed Feb. 23, 2009; U.S. Patent Publication No. 2010/0123403, published May 20, 2010; PCT Publication No. WO2010/057115, published May 20, 2010; U.S. Provisional Patent Application No. 61/174,913, filed May 1, 2009; U.S. Pat. No. 8,926,139, issued Jan. 6, 2015; PCT Publication No. WO2010/127138, published Nov. 4, 2010; U.S. Provisional Patent Application No. 61/180,017, filed May 20, 2009; U.S. Pat. No. 8,872,964, issued Oct. 28, 2014; U.S. Patent Publication No. 2015/0015716, published Jan. 15, 2015; PCT Publication No. WO2010/135575, published Nov. 25, 2010; U.S. Provisional Patent Application No. 61/229,435, filed Jul. 29, 2009; U.S. Patent Publication No. 2011/0026264, published Feb. 3, 2011; U.S. Provisional Patent Application No. 61/295,519, filed Jan. 15, 2010; U.S. Provisional Patent Application No. 61/406,490, filed Oct. 25, 2010; U.S. Pat. No. 8,378,563, issued Feb. 19, 2013; PCT Publication No. WO2011/088363, published Jul. 21, 2011; U.S. Provisional Patent Application No. 61/333,983, filed May 12, 2010; U.S. Pat. No. 8,541,950, issued Sep. 24, 2013; PCT Publication No. WO2010/135577, published Nov. 25, 2010; U.S. Provisional Patent Application No. 61/346,263, filed May 19, 2010; U.S. Pat. No. 8,508,137, issued Aug. 13, 2013; U.S. Pat. No. 8,810,138, issued Aug. 19, 2014; U.S. Pat. No. 8,987,992, issued Mar. 24, 2015; PCT Publication No. WO2010/135582, published Nov. 25, 2010; U.S. Provisional Patent Application No. 61/357,421, filed Jun. 22, 2010; U.S. Patent Publication No. 2011/0310605, published Dec. 22, 2011; PCT Publication No. WO2011/163334, published Dec. 29, 2011; U.S. Pat. No. 8,901,825, issued Dec. 2, 2014; U.S. Patent Publication No. 2015/0084520, published Mar. 26, 2015; PCT Publication No. WO2012/142115, published Oct. 18, 2012; U.S. Pat. No. 8,610,358, issued Dec. 17, 2013; U.S. Provisional Patent Application No. 61/527,029, filed Aug. 24, 2011; U.S. Pat. No. 8,629,621, issued Jan. 14, 2014; PCT Publication No. WO2013/028834, published Feb. 28, 2013; U.S. Provisional Patent Application No. 61/534,722, filed Sep. 14, 2011; U.S. Patent Publication No. 2013/0062637, published Mar. 14, 2013; PCT Publication No. WO2013/040333, published Mar. 21, 2013; U.S. Provisional Patent Application No. 61/567,308, filed Dec. 6, 2011; U.S. Patent Publication No. 2013/0163243, published Jun. 27, 2013; U.S. Provisional Patent Application No. 61/561,616, filed Nov. 18, 2011; U.S. Patent Publication No. 2013/0141010, published Jun. 6, 2013; PCT Publication No. WO2013/074900, published May 23, 2013; U.S. Provisional Patent Application No. 61/641,781, filed May 2, 2012; U.S. Patent Publication No. 2013/0293112, published Nov. 7, 2013; U.S. Patent Publication No. 2013/0229518, published Sep. 5, 2013; U.S. Provisional Patent Application No. 61/640,963, filed May 1, 2012; U.S. Patent Publication No. 2013/0313982, published Nov. 28, 2013; U.S. Patent Publication No. 2014/0028198, published Jan. 30, 2014; PCT Publication No. WO2014/018773, published Jan. 30, 2014; U.S. Provisional Patent Application No. 61/723,675, filed Nov. 7, 2012; U.S. Patent Publication No. 2014/0159585, published Jun. 12, 2014; U.S. Provisional Patent Application No. 61/692,619, filed Aug. 23, 2012; U.S. Patent Publication No. 2014/0055990, published Feb. 27, 2014; U.S. Provisional Patent Application No. 61/694,159, filed Aug. 28, 2012; U.S. Pat. No. 8,878,440, issued Nov. 4, 2014; U.S. Patent Publication No. 2014/0062341, published Mar. 6, 2014; U.S. Patent Publication No. 2015/0077019, published Mar. 19, 2015; PCT Publication No. WO2014/039683, published Mar. 13, 2014; U.S. Provisional Patent Application No. 61/728,150, filed Nov. 19, 2012; U.S. Patent Publication No. 2014/0139116, published May 22, 2014; PCT Publication No. WO2014/078854, published May 22, 2014; U.S. Provisional Patent Application No. 61/764,395, filed Feb. 13, 2013; U.S. Patent Publication No. 2014/0225521, published Aug. 14, 2014; U.S. Provisional Patent Application No. 61/849,841, filed Jul. 24, 2013; U.S. Patent Publication No. 2015/0028693, published Jan. 29, 2015; PCT Publication No. WO2015/013437, published Jan. 29, 2015; U.S. Provisional Patent Application No. 61/878,425, filed Sep. 16, 2013; U.S. Patent Publication No. 2015/0078005, published Mar. 19, 2015; PCT Publication No. WO2015/039120, published Mar. 19, 2015; U.S. Provisional Patent Application No. 61/933,733, filed Jan. 30, 2014; U.S. Non-Provisional patent application Ser. No. 14/609,168, filed Jan. 29, 2015; PCT Publication No. WO2015/116812, published Aug. 6, 2015; U.S. Provisional Patent Application No. 61/905,699, filed Nov. 18, 2013; U.S. Patent Publication No. 2015/0137693, published May 21, 2015; U.S. Provisional Patent Application No. 62/068,517, filed Oct. 24, 2014; U.S. Provisional Patent Application No. 62/183,505, filed Jun. 23, 2015; U.S. Provisional Patent Application No. 62/082,463, filed Nov. 20, 2014; U.S. Provisional Patent Application No. 62/057,419, filed Sep. 30, 2014; U.S. Provisional Patent Application No. 62/114,826, filed Feb. 11, 2015; U.S. Provisional Patent Application No. 62/137,666, filed Mar. 24, 2015 and U.S. Provisional Patent Application No. 62/208,403, filed Aug. 21, 2015 are incorporated herein by reference, in their entirety. Aspects of the implementations can be modified, if necessary, to employ systems, circuits and concepts of the various patents, applications and publications to provide yet further implementations.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1.-22. (canceled)

23. A method of operation in a luminaire control system, the method comprising:
receiving at least a first signal via a communications port,
in response to receipt of the first signal, entering into a stored energy consuming mode by at least one controller, and
in the stored energy consuming mode, determining, by the at least one controller, whether there is sufficient stored power to power a luminaire through a dusk-to-dawn cycle, independent of whether electrical power to power the luminaire is available via a line, grid or mains power source.

24. The method of claim 23, further comprising:
in the stored energy consuming mode, determining, by the at least one controller, whether to apply an illumination adjustment schedule based at least in part on an at least estimate of a length of the dusk-to-dawn cycle and based at least in part on an at least estimate of stored power available to power the luminaire through the dusk-to-dawn cycle.

25. The method of claim 24, further comprising:
in the stored energy consuming mode, selecting, by the at least one controller, between two or more dimming schedules based at least in part on an at least estimate of stored power available to power the luminaire through the dusk-to-dawn cycle.

26.-43. (canceled)

44. A luminaire control system to control operation of a luminaire, the luminaire control system comprising:
at least one nontransitory processor-readable medium that stores at least one of processor executable instructions or data; and
at least one controller communicatively coupled to the at least one nontransitory processor-readable medium and coupled to control operation of the luminaire, the at least one controller which in at least one mode determines whether there is sufficient stored power to power the luminaire through a dusk-to-dawn cycle, independent of whether electrical power to power the luminaire is available via a line, grid or mains power source.

45. The luminaire control system of claim 44 wherein, in the at least one mode, the at least one controller determines whether to apply an illumination adjustment schedule based at least in part on an at least estimate of a length of the dusk-to-dawn cycle and based at least in part on an at least estimate of stored power available to power the luminaire through the dusk-to-dawn cycle.

46. The luminaire control system of claim 45 wherein, in the at least one mode, the at least one controller selects between two or more illumination adjustment schedules based at least in part on an at least estimate of stored power available to power the luminaire through the dusk-to-dawn cycle, and executes the selected one of the illumination adjustment schedules to control an illumination level of the luminaire during a dusk to dawn period.

47. The luminaire control system of claim 46 wherein at least the selected illumination adjustment schedule executed by the at least one controller specifies a period of time in which the luminaire is controlled to output at a reduced but non-zero level of illumination with respect to another period.

48. The luminaire control system of claim 45 wherein, in the at least one mode, the at least one controller compares the at least estimated power available to power the luminaire through the dusk-to-dawn cycle to a respective estimated amount of power required to power the luminaire through the dusk-to-dawn cycle for each of a plurality of dimming schedules.

49. The luminaire control system of claim 44 wherein, in the at least one mode, the at least one controller estimates power available to power the luminaire through the dusk-to-dawn cycle based at least in part on an at least an estimate of solar insolation that occurred in at least a portion of a most immediate dawn-to-dusk cycle.

50. The luminaire control system of claim 44 wherein, in the at least one mode, the at least one controller integrates a signal indicative of an output value of a light sensitive transducer over at least a portion of the most immediate dawn-to-dusk cycle in order to at least estimate an amount of power generated by the renewable energy source in the most immediate dawn-to-dusk cycle.

51. The luminaire control system of claim 44, further comprising:
at least one global positioning receiver communicatively coupled to the at least one controller to provide information thereto indicative of at least one of a latitude or a longitude of the luminaire, wherein the at least one controller determines the at least an estimate of the length of the dusk-to-dawn cycle based on the information indicative of the at least one of the latitude or the longitude of the luminaire.

52. The luminaire control system of claim 44 wherein the at least one nontransitory processor-readable medium stores location information indicative of at least one of a latitude or a longitude of the luminaire, and the least one controller determines the at least an estimate of the length of the dusk-to-dawn cycle based on the information indicative of the at least one of the latitude or the longitude of the luminaire.

53. A method of operation in a luminaire control system to control operation of a luminaire, method comprising:
in at least one mode, determining, by at least one controller, whether there is sufficient stored power to power the luminaire through a dusk-to-dawn cycle, independent of whether electrical power to power the luminaire is available via a line, grid or mains power source; and
controlling the luminaire via stored power independent of whether electrical power to power the luminaire is available via a line, grid or mains power source.

54. The method of claim 53, further comprising:
in the at least one mode, determining, by the at least one controller, whether to apply an illumination adjustment schedule based at least in part on an at least estimate of a length of the dusk-to-dawn cycle and based at least in part on an at least estimate of stored power available to power the luminaire through the dusk-to-dawn cycle.

55. The method of claim 54, further comprising:
in the at least one mode, selecting, by the at least one controller, between two or more dimming schedules based at least in part on an at least estimate of stored power available to power the luminaire through the dusk-to-dawn cycle, and executes the selected one of the dimming schedules to control an illumination level of the luminaire during a dusk to dawn period.

56. The method of claim 55 wherein, in response to at least the selected dimming schedule, the controlling the luminaire via stored power includes controlling the luminaire to output at a reduced but non-zero level of illumination with respect to another period.

57. The method of claim 54, further comprising:
in the at least one mode, comparing, by the at least one controller, the at least estimated power available to power the luminaire through the dusk-to-dawn cycle to a respective estimated amount of power required to power the luminaire through the dusk-to-dawn cycle for each of a plurality of dimming schedules.

58. The method of claim 53, further comprising:
in the at least one mode, estimating, by the at least one controller, an amount of power available to power the luminaire through the dusk-to-dawn cycle based at least in part on an at least an estimate of solar insolation that occurred in at least a portion of a most immediate dawn-to-dusk cycle.

59. The method of claim 53, further comprising:
in the at least one mode, integrating, by the at least one controller, a signal indicative of an output value of a light sensitive transducer over at least a portion of the most immediate dawn-to-dusk cycle in order to at least estimate an amount of power generated by the renewable energy source in the most immediate dawn-to-dusk cycle.

60. The method of claim 53, further comprising:
generating, by at least one global positioning receiver, information thereto indicative of at least one of a latitude or a longitude of the luminaire, and wherein the determining the at least an estimate of the length of the dusk-to-dawn cycle is based on the information indicative of the at least one of the latitude or the longitude of the luminaire.

61. The method of claim 53, further comprising:
retrieving from at least one nontransitory processor-readable medium, location information indicative of at least one of a latitude or a longitude of the luminaire, and wherein the determining the at least an estimate of the length of the dusk-to-dawn cycle is based on the information indicative of the at least one of the latitude or the longitude of the luminaire.

62.-69. (canceled)

70. A method of operation in a luminaire control system to control operation of a luminaire, the method comprising:
in at least one mode, determining, by at least one controller, whether to apply a illumination adjustment schedule based at least in part on an at least estimate of a length of the dusk-to-dawn cycle and based at least in part on an at least estimate of stored power available to power the luminaire through the dusk-to-dawn cycle; and
controlling the luminaire via stored power independent of whether electrical power to power the luminaire is available via a line, grid or mains power source.

71. The method of claim 70, further comprising:
in the at least one mode, selecting, by the at least one controller, between two or more dimming schedules based at least in part on an at least estimate of stored power available to power the luminaire through the dusk-to-dawn cycle, and executes the selected one of the dimming schedules to control an illumination level of the luminaire during a dusk to dawn period.

72. (canceled)

73. The method of claim 70, further comprising:
in the at least one mode, comparing, by the at least one controller, the at least estimated power available to power the luminaire through the dusk-to-dawn cycle to a respective estimated amount of power required to power the luminaire through the dusk-to-dawn cycle for each of a plurality of dimming schedules.

74.-91. (canceled)
